(19) United States
(12) Patent Application Publication
(10) Pub. No.: US 2017/0161967 A1
(43) Pub. Date: Jun. 8, 2017

(54) VEHICLE OPERATION MANAGEMENT SYSTEM

(71) Applicant: Matsuo Associates Inc., Tokyo (JP)

(72) Inventor: Nakahiko Matsuo, Tokyo (JP)

(21) Appl. No.: 15/303,365

(22) PCT Filed: Apr. 9, 2015
(86) PCT No.: PCT/JP2015/061178

§ 371 Date: Oct. 11, 2016

(30) Foreign Application Priority Data
Apr. 11, 2014 (JP) 2014-082014
Oct. 23, 2014 (JP) 2014-216653

(51) Int. Cl. G07C 5/00; G07C 5/08

(52) U.S. Cl. CPC G07C 5/008; G07C 5/085

(57) ABSTRACT

[Object]

Object of the invention is to provide a digi-tacho system that is cheap and able to respond easily to change and expansion of the system configuration.

[Solution]

A tachograph on-vehicle device comprises a speed data acquisition unit 5 connected with a sensor 8 provided on the drive mechanism of a vehicle, and a general-purpose terminal 4. The general-purpose terminal 4 is a smartphone or mobile computer. The speed data acquisition unit 5 is capable of data transfer to the general-purpose terminal 4 by a general-purpose interface cable or short-distance wireless communication. The speed data at each time in the vehicle operation is transmitted to a management server 1 via the general-purpose terminal 4 at every transmission interval and recorded in a results data file 26 memorized in a storage device 2. Contents of the results data file 26 including a digi-tacho triple element are browsed on a management terminal 3 by accessing via the Internet 6. The general-purpose terminal 4 is mounted demountably on a holder so as not to fall down during the vehicle running.

### TECHNICAL FIELD

The invention of this application relates to a vehicle operation management system including a digital tachograph.

### TECHNICAL BACKGROUND

A tachograph is a kind of operation recording meter mounted in a vehicle. It is the meters capable of confirming the operation situation of the vehicle by graphing change of the travel speed during the operation. In the data recorded on the tachograph, the travel time, the travel distance and the speed (instantaneous speed) are called “triple basic element”. Recently, a digital tachograph, hereafter called “digi-tacho”, that records each element as digital information has been popular. Hereafter, the travel time, the travel distance and the instantaneous speed are called “digi-tacho triple element” or “triple element” simply.

Such a tachograph can be used preferably for operation management, e.g., safety management or work management, to prevent safety-lacking operation such as excessive speeding and irrational long-time driving. Moreover, it can be utilized for operation with lesser fuel consumption by making drivers refrain from waste rapid acceleration and revving. Therefore, it leads to the corporate publicity as an eco-conscious company in addition to the expense reduction. Accordingly, vehicle operation management systems using tachographs, in particular, digi-tachos, are on sale, and used in major transportation companies and taxicab companies.

The Ministry of Land, Infrastructure, Transport and Tourism of Japan (MLIT) also emphasizes significance of vehicle operation management systems using digi-tachos. The MLIT has announced their policy of making tachographs more popular and expanding those use in view of more concentrated traffic safety program to reduce the number of accidents. In this policy, the obligation of tachograph installation will be expanded to commercial trucks of 7-to-8 tons in total weight.

Among vehicle operation management systems using digi-tachos, hereafter called “digi-tacho systems”, functional upgrading including the network availability is ongoing. A digi-tacho mounted in a vehicle, hereafter called “digi-tacho on-vehicle device”, may be available on such a network as the Internet. Sales companies of digi-tacho systems prepare kinds of software for operation management on servers on the network. They also provide vehicle operation management services utilizing those kinds of software for digi-tacho buyers, e.g., transportation companies.

Moreover, installation of a drive recorder in addition to the digi-tacho on-vehicle device is being poplar as functional upgrading. On a vehicle having a drive recorder, data of an image in front of the vehicle is obtained at the moment it is captured in addition to the data of the digi-tacho triple element. Therefore, it is profitable to confirm the situation in case of an accident.

Although such a high-grade digi-tacho system is very profitable in view of safety management and work management, however, it has the defect of high price and high running cost, e.g., large fee for use of the software. By contrast to the high-grade systems as described, low-price digi-tachos with limited functions are also on sale. This kind of digi-tacho is a recording meter limited to the data collection of the digi-tacho triple element. In this kind of digi-tacho, the data is imported by such a media as memory card. As described above, the current situation of the digi-tacho industry may be, so to speak, bipolarizing.

### PRIOR-ART REFERENCES

### Patent Document

Patent Document: JP2013-141126A

### SUMMARY OF THE INVENTION

### Problems Solved by the Invention

As described above, a digi-tacho system is very profitable in view of safety management for commercial vehicles and work management for drivers, further in view of the expense reduction and the eco-commitment. Therefore, digi-tacho systems are expected to spread to the society widely, possibly through expansion of the obligation. In the actual transportation industry, however, a lot of medium-small-sized companies and micro-sized transportation companies exist in addition to major transportation companies. For these medium-small and micro sized transportation companies, a large capital investment is difficult because of the small merchandising scale and the weak management strength. Therefore, they can hardly introduce a high-grade digi-tacho system even though recognize it profitable. Situation in the taxicab industry and in-house logistics is the same. For medium-small sized taxicab companies and small-sized in-house logistics companies, introduction of digi-tacho systems is difficult because it needs much investment and lots of expense. According to an estimation, the number of commercial vehicles for which digi-tacho systems have been introduced is presumed to be as low as about 600,000 (7% of the whole).

On the other hand, low-price digi-tachos only have much limited functions. This kind of digi-tacho cannot perform sufficient analysis of operation situation by adequate data processing. Moreover, even such a simple function as refrigerator-door-close check in a refrigerated truck cannot be added for instance. In a word, it has the defect of lacking the extendibility.

For any type, high grade or low price, it is necessary to remake an overall on-vehicle device, that is, develop newly, when the system configuration is improved or upgraded, because a special digi-tacho (special-purpose device) is mounted as the on-vehicle device. The user needs to buy a newly developed on-vehicle device, exchange it from the old one and mount it. Actually, the configuration of a digi-tacho system needs to be renewed to respond to a change of the industry environment, respond to a change of traffic situation, and respond to a change brought by innovation in the vehicle technology. For a conventional system where a special digi-tacho is mounted as the on-vehicle device, it could be much expensive because the digi-tacho has to be wholly replaced. If collection of a new element of data is obligated by a law revision after a company introduces a low-grade digi-tacho because of its low price, for instance, they would need to replace the whole of the on-vehicle device to a new one. In this case, the cost would be rather expensive than intended.

The invention of this application was made in consideration of the above-described problem concerning to the digi-tacho systems. The purpose of the invention of this application is to provide a digi-tacho system being able to respond easily to change and expansion of the system configuration as well as being cheap so that even a company weak in the management strength can introduce, thereby contributing to a further social spread of the digi-tacho technology.

### Means for Solving the Problem

To solve the described problem, the invention as claimed in the claim 1 of this application is a vehicle operation management system comprising a tachograph on-vehicle device mounted on a vehicle, a management server and a storage device,

wherein

the tachograph on-vehicle device comprises
a terminal that is a smartphone or tablet computer, and
a signal collecting unit to collect vehicle information to transmit to the terminal,

the terminal is capable of accessing the management server via a packet communication system,

a vehicle speed pulse is included in the vehicle information collected by the signal collection unit,

the terminal is the one to transmit the vehicle information to the management server via the packet communication system,

a program to memorize travel distance, travel time and travel speed by processing the vehicle speed pulse transmitted from the terminal is implemented on the management server, and

by being transmitted from the management server to an in-office terminal via the Internet, the travel distance, the travel time and the travel speed are capable of being browsed on the in-office terminal.

To solve the described problem, the invention as claimed in the claim 2 of this application is a vehicle operation management system comprising a tachograph on-vehicle device, a management server and a storage device,

wherein

the tachograph on-vehicle device comprises
a speed data acquisition unit connected with a sensor provided on a drive mechanism of the vehicle, and
a general-purpose terminal connected with the speed data acquisition unit,

the general-purpose terminal is a smartphone or a mobile computer excluding smartphones, which is capable of accessing the management server via a network,

in the general-purpose terminal is installed an on-vehicle device application software including a data memorization module to transmit the speed data to the management server at every transmission interval and make the speed data memorized in the storage device, the speed data being acquired by the speed data acquisition unit at every acquisition interval,

the management server is the server to receive an access from the general-purpose terminal via the network,

vehicle operation management server software including a results data registration program is implemented on the management server,

a results data file is memorized in the storage device,

the results data registration program is the program to record the speed data transmitted from the general-purpose terminal by the data memorization module in the results data file for registration,

the vehicle operation management server software includes a triple-element browse program,

the triple-element browse program is the program to display the triple element on a management terminal on the basis of the speed data recorded in the results data file, the triple element being travel distance, travel time and travel speed in one day work or one time work,

a terminal holder is fixed on the vehicle, the terminal holder holding the general purpose terminal demountably and pretending the general purpose terminal from falling down during the vehicle running,

the speed data acquisition unit and the general-purpose terminal are capable of transferring the speed date either by a general-purpose interface cable connection or short-distance wireless communication.

To solve the described problem, the invention as claimed in the claim 3 of this application is a vehicle operation management system as claimed in the claim 2,

wherein

the speed data acquisition unit has a general-purpose interface output port,

the terminal holder has a general-purpose interface connector port to be in contact with a general-purpose interface input port of the general-purpose terminal mounted thereon,

the general-purpose interface connector port is connected to the general-purpose interface output port of the speed data acquisition unit by a general-purpose interface cable.

To solve the described problem, the invention as claimed in the claim 4 of this application is a vehicle operation management system as claimed in the claim 2,

wherein

the general-purpose terminal has a short distance wireless receiver based on a general-purpose interface standard,

the speed data acquisition unit has a general-purpose interface transmitter based on the same general-purpose interface standard as the short distance wireless receiver of the general-purpose terminal.

To solve the described problem, the invention as claimed in the claim 5 of this application is a vehicle operation management system as claimed in the claim 4,

the general-purpose interface transmitter and the short-distance wireless receiver are capable of data transfer without facing to each other.

To solve the described problem, the invention as claimed in the claim 6 of this application is a vehicle operation management system as claimed in the claim 2, 3, 4 or 5,

wherein

the vehicle belongs to a vehicle operating company,

another or other vehicles belong to the same vehicle operating company,

the speed data acquisition unit and the general-purpose terminal are mounted on each vehicle,

in the storage device are memorized a vehicle information file where vehicle information including vehicle ID of each vehicle is recorded, and a work information file where work information is recorded,

a work registration program is included in the vehicle operation management server software,

the on-vehicle device application software includes a work start module to be executed in starting a work,

the work start module is the program module to make the vehicle ID input, transmit the vehicle ID to the management server so that the vehicle ID is recorded in the work information file by the work registration program,

the triple element browse program is the program to acquire information of the vehicle as data source from the vehicle information file and make the information displayed on the management terminal together with the triple-element.

To solve the described problem, the invention as claimed in the claim 7 of this application is a vehicle operation management system as claimed in the claim 2, 3, 4, 5 or 6,

wherein

the speed data acquired by the speed data acquisition unit is vehicle speed pulse,

the results data registration program implemented on the management server is the program to calculate the travel speed by converting the vehicle speed pulse.

To solve the described problem, the invention as claimed in the claim 8 of this application is A vehicle operation management system as claimed in the claim 2, 3, 4, 5, 6 or 7,

wherein

the speed data acquisition unit has an input port to which a signal from anther device mounted on the vehicle than the sensor is input,

the speed data acquisition unit is the unit to output data based on the signal from the other device together with the speed data to the general-purpose terminal,

the data memorization module collects the data based on the signal from the other device and the speed data to transmit to the management server,

the results data registration program is the program to record the data based on the signal from the other device together with the speed data in the results data file.

To solve the described problem, the invention as claimed in the claim 9 of this application is a vehicle operation management system managing at least vehicle travel speed, comprising a tachograph on-vehicle device mounted on a vehicle, a management server, and a storage device,

wherein

the tachograph on-vehicle device comprises

a speed data acquisition unit connected with a sensor provided on a drive mechanism of the vehicle, and

a general-purpose terminal connected with the speed data acquisition unit,

the general-purpose terminal is a smartphone or a mobile computer excluding smartphones, which is capable of accessing the management server via a network,

in the general-purpose terminal is installed on-vehicle device application software including a data memorization module to transmit the speed data acquired by the speed data acquisition unit to the management server,

the management server is the server to receive accesses from the general-purpose terminal and a management terminal via the network,

vehicle operation management server software including a results data register program is implemented on the management server,

a results data file is memorized in the storage device,

the results data registration program is the program to record the speed data transmitted from the general-purpose terminal by the data memorization module in the results data file for registration,

the vehicle operation management server software includes a browse program,

the browse program is the program to display the speed data recorded in the results data file on the management terminal,

a terminal holder is fixed in the vehicle, the terminal holder holding the general purpose terminal demountably and pretending the general-purpose terminal from falling down during the vehicle running,

the speed data acquisition unit and the general-purpose terminal are capable of transferring the speed data either by a general-purpose interface cable connection or short-distance wireless communication.

### Effect of the Invention

As described below, according to the invention of the claim 1 of this application, the cost for introducing the system is much cheaper than before, because the on-vehicle device comprises the terminal, which is a smartphone or tablet computer, and the speed data acquisition unit, and because the main function of transmitting of the speed data to the management server is allocated to the smartphone or tablet computer.

According to the invention of the claim 2 or 9, the cost for introducing the system becomes much cheaper compared to conventional systems, because the on-vehicle device comprises the speed data acquisition unit and the general-purpose terminal, and because the general-purpose terminal performs the main function of transmitting the speed data to the management server, and because the general-purpose terminal is a smart phones or other general-purpose mobile computers.

According to the invention described in claim 3, because the terminal holder holds the general-purpose terminal so as not to fall down during the vehicle running, and because this terminal holder has the general-purpose interface connector port to be in contact with the general-purpose interface input port of the general-purpose terminal when mounded, moreover, it is possible to import the speed data to the general-purpose terminal only by mounting it on the terminal holder connected beforehand to the speed data acquisition unit with a general-purpose interface cable. Therefore, it is very convenient.

According to the invention described in claim 4, moreover, the interior of the vehicle does not seem messy because of no exposed cable. A development cost and system cost would be cheaper because it is not required to develop a special terminal holder even if no special terminal holder for the general-purpose terminal is on sale.

According to the invention of the claim 5, moreover, the system is preferable especially for a vehicle where the speed data acquisition unit and the general-purpose terminal are mounted on the dashboard, because the short-distance wireless transmitter and the short-distance wireless receiver are capable of data transfer without facing to each other.

According to the invention of the claim 6, moreover, the system has the advantage of enabling elaborate management according to property of vehicles.

According to the invention of the claim 7, moreover, the system is free from the problem of slower transmission of the speed data because the load on the general-purpose terminal is small.

According to the invention of the claim 8, moreover, the system is preferable in advancing and upgrading the vehicle operation management, because data teaching the status of the vehicle is acquired via the speed data acquisition unit in addition to the digi-tacho triple element. In this case, though the direct data transfer to the general-purpose terminal might suffer limitation of the number of the general-purpose interface connector ports on the general-purpose terminal, the invention of claim 7 is also free from this kind of problem.

### BRIEF DESCRIPTION OF THE DRAWINGS

FIG. 1 schematically shows the vehicle operation management system of the first embodiment.

FIG. 2 schematically shows installation of the on-vehicle device in the vehicle.

FIG. 3 is a 3D schematic view showing the terminal holder and the mounting structure of the general-purpose terminal by the terminal holder.

FIG. 4 shows the schematic structure of the speed data acquisition unit in the embodiment.

FIG. 5 schematically shows the structure of the on-vehicle device application program.

FIG. 6 schematically shows one example of the main window displayed by the main module of the on-vehicle device application program.

FIG. 7 schematically shows the flow chart of the work start module.

FIG. 8 schematically shows one example of the structure of the vehicle information file.

FIG. 9 schematically shows one example of the vehicle selection window.

FIG. 10 is a flow chart showing the outline of the data memorization module.

FIG. 11 schematically shows one example of the structure of the temporary file.

FIG. 12 is a flow chart showing the outline of the data transmission sub.

FIG. 13 schematically shows the structure of the work information file as an example.

FIG. 14 schematically shows the structure of the results data file as an example.

FIG. 15 schematically shows one example of the initial screen displayed on the management terminal by the operation management application program.

FIG. 15 schematically shows one example of an initial window, hereafter displayed on the management terminal by the ope-management application.

FIG. 16 schematically shows one example of the triple element browse window displayed on the management terminal.

FIG. 17 schematically shows one example of the inspection-monitoring window displayed on the management terminal by the inspection-monitoring program.

FIG. 18 schematically shows one example of the eco-evaluation window displayed on the management terminal by the eco-evaluation program.

FIG. 19 schematically shows one example of the safety management window displayed on the management terminal by the safety management program.

FIG. 20 schematically shows the main part of the vehicle operation management system of the second embodiment.

### MODE TO PRACTICE THE INVENTION

Next, a mode to practice the invention of this application, hereafter called “embodiment”, is described.

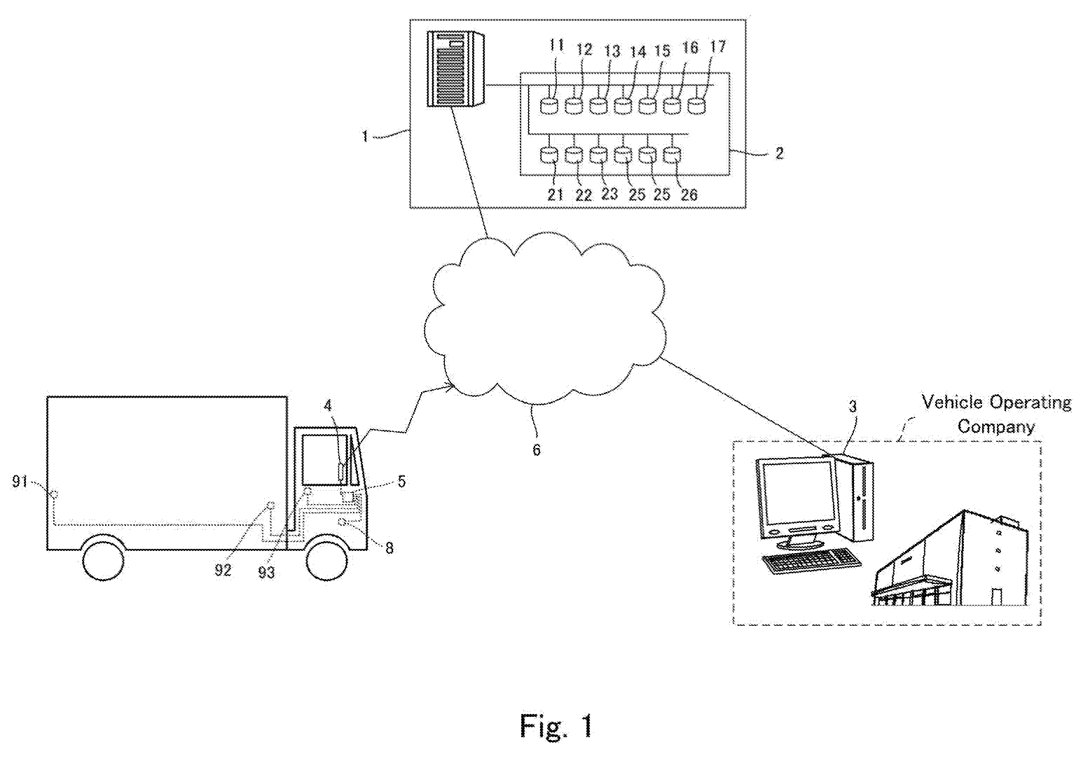

FIG. 1 schematically shows the vehicle operation management system of the first embodiment. The vehicle operation management system shown in FIG. 1 is a digi-tacho system, and includes a tachograph on-vehicle device, hereafter called “on-vehicle device”, mounted to the vehicle, a management server 1, a storage device 2, and a management terminal 3.

The major feature of the vehicle operation management system of the embodiment is that the on-vehicle device is not a special device but includes a general-purpose terminal 4 as a component. The on-vehicle device in the embodiment comprises a speed data acquisition unit 5 connected with a sensor 8 provided in the drive mechanism of the vehicle, and a general-purpose terminal 4 connected with the speed data acquisition unit 5.

First of all, the general-purpose terminal 4 and the speed data acquisition unit 5, which are components of the on-vehicle device, are described.

The general-purpose terminal 4 is a smartphone or another general-purpose portable computer than smartphone. For instance, it is an about 10-inch sized tablet PC. The general-purpose terminal 4 is accessible to the management server 1 via a network. In this embodiment, the Internet 6 is assumed as the network. It may be a cellular phone network or wireless LAN to connect the general-purpose terminal 4 with the Internet 6. As well known, the general-purpose terminal 4 has a mobile data communication interface.

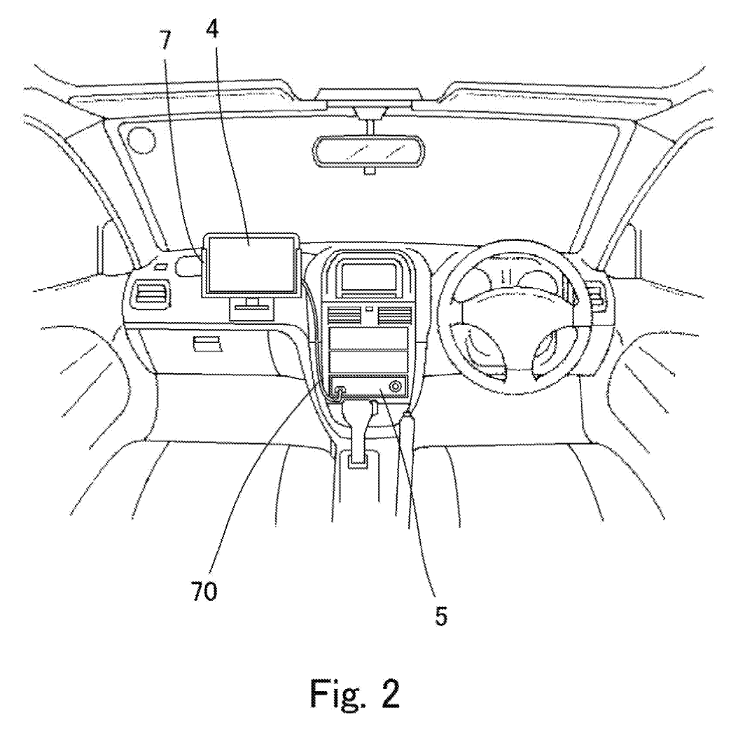

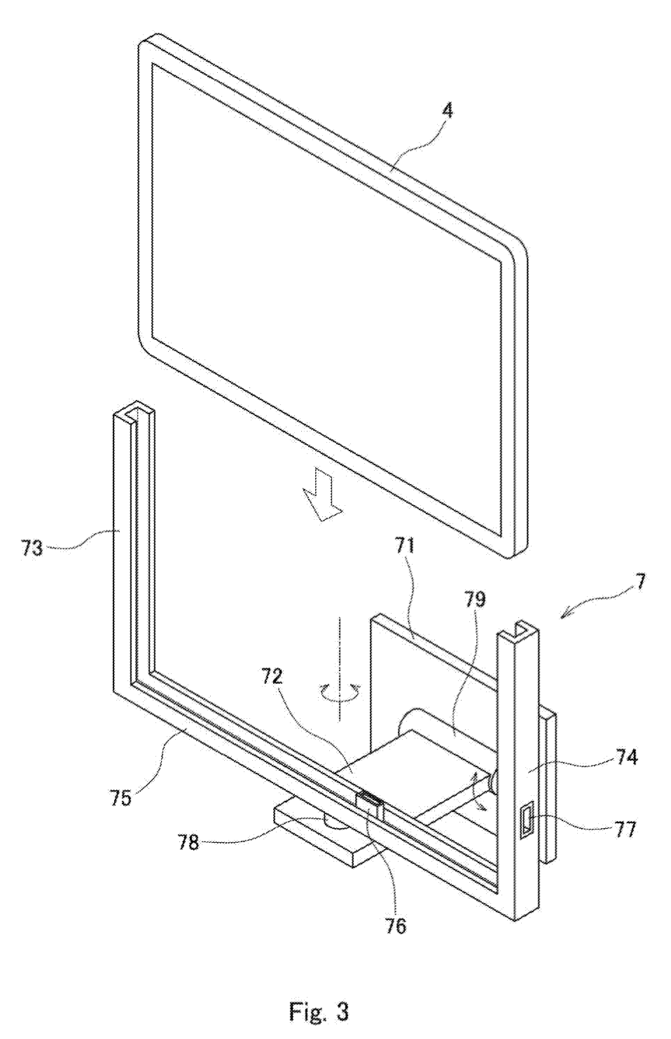

FIG. 2 schematically shows installation of the on-vehicle device in the vehicle. The general-purpose terminal 4 of the on-vehicle devices is mounted and held on the terminal holder 7 as shown in FIG. 2. The terminal holder 7 is fixed to a dashboard. FIG. 3 is a 3D schematic view showing the terminal holder 7 and the mounting structure of the general-purpose terminal 4 by the terminal holder 7.

The terminal holder 7 in this example is frame-shaped as shown in FIG. 3, though it can have any kinds of structure. The terminal holder 7 has a baseboard 71 fixed to the dashboard of the vehicle, an arm 72 lengthened from the baseboard 71, and frames 73-75 provided at the top of the arm 72. The base board 71 is the part fastened to the dashboard by screwing. In this example, the frames 73-75 form a U-shape, and have the structure to hold the general-purpose terminal 4 at both side portions and the bottom portion. The small prop 78 having a vertical swivel inside is provided at the top of the arm 72. The prop 78 supports the frames 73-75.

A groove corresponding to the thickness of the general-purpose terminal 4 is formed in each frame 73-75. As shown in FIG. 3, the general-purpose terminal 4 is inserted down to the terminal holder 7 and put into the groove of each frame 73-75 when mounted. The distance between the frames 73, 74 at both sides is slightly narrower than the width of the general-purpose terminal 4. The both-side frames 73, 74 have some elasticity. Therefore, when the general-purpose terminal 4 is inserted as described, the both side frames 73 and 74 are opened a little by the elasticity. Therefore, pressure is applied to the general-purpose terminal 4 by the restoring force of the both side frames 73, 74. As a result, the general-purpose terminal 4 is held firmly. Therefore, the general purpose terminal 4 does not fall down while the vehicle is running. As another structure, the general-purpose terminal 4 may be pinched by the elasticity of a cushion material provided in the groove of the frames 73-75.

As shown in FIG. 2, a connector port 76 to be in contact with a general-purpose interface port of the general-purpose terminal 4 is provided in the groove of the lower frame 75. In this embodiment, USB is assumed as the general-purpose interface. Therefore, the connector port 76 is a USB port. Because the USB port of the general-purpose terminal 4 is usually female, the connector port (USB port) 76 provided in the groove of the lower frame 75 is male.

An external USB port (female) 77 is provided on the outer surface of the right frame 74. The external USB port 77 and the connector port 76 are connected by a wire (not shown) provided in the frames 74 and 75. Therefore, the general-purpose terminal 4 can be in the USB connection with another device by connecting a USB cable (general-purpose interface cable) 70 to the external USB port 77. This structure is simple because the USB connection is completed only by inserting the general-purpose terminal 4 into the terminal holder 7 if a USB cable 70 is connected in advance with the external USB port 77 of the terminal holder 7.

In demounting the general-purpose terminal 4 from the terminal holder 7, it is lifted up as the right and left frames 73 and 74 are pushed out a little. That is, the terminal holder 7 is the demountable holder for the general-purpose terminal 4.

The base board 71 and the arm 72 are connected by a joint 79 having a horizontal swivel inside. Therefore, the tilt angle of the arm 72 and the frames 73-75 to the vertical direction can be adjusted. Because the frames 73-75 are supported with the prop 78 having the vertical swivel inside, the tilt angle of them to the horizontal direction can be adjusted too. Therefore, the general-purpose terminal 4 held in the frames 73-75 can have an adequate posture by adjusting the tilt angles.

As shown in FIG. 2, the terminal holder 7 is installed at the position where a driver sitting in the driver's seat can tap the display of the general-purpose terminal 4. The posture of the frames 73-75 of the terminal holder 7 is adequately adjusted as described. By this, the general-purpose terminal 4 is directed to an adequate direction.

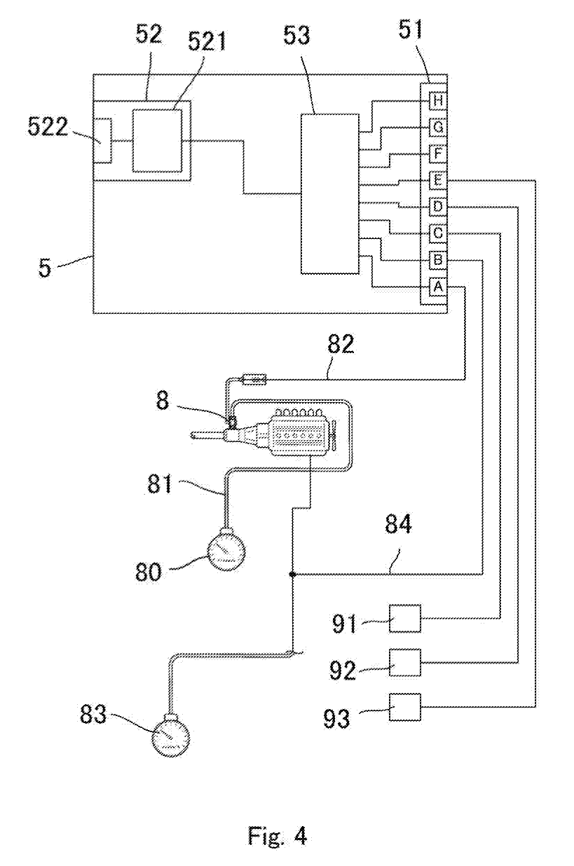

Next, the speed data acquisition unit 5 is described. FIG. 4 schematically shows the configuration of the speed data acquisition unit 5 in the embodiment. The speed data acquisition unit 5 is the unit to acquire the speed data, which is necessary for the vehicle operation management, from the sensor 8 on the drive mechanism. In this embodiment, a lot of elements of the conventional on-vehicle device are replaced by the general-purpose terminal 4. An element not replaced is the speed data acquisition unit 5.

The speed data acquisition unit 5 is connected to a signal wire 82 branching from another signal wire 81 to a speedometer 80 installed in the vehicle. This speedometer 80 may be an electric type or mechanical type. An electric type speedometer measures the speed according to the number of engine rotation, which is known from the voltage applied to the ignition coil. A mechanical type speedometer measures the speed according to the number of rotation detected mechanically by a gear mechanism provided in the crankshaft of an engine. Any type of speedometer may be used for the speed data acquisition unit 5 in the embodiment. A new signal wire is provided branching from the signal wire to the speedometer. The installed speed data acquisition unit 5 is connected to this signal wire. In these examples, an element detecting the voltage applied to the ignition coil or the gear mechanism installed on the crankshaft corresponds to “a speed sensor provided on the drive mechanism of the vehicle”. The speedometer 80 shown in FIG. 4 is the mechanical type.

In any type, electric or mechanical, the signal to be sent is digitalized, i.e., pulse signal, which is hereafter called “vehicle speed pulse”. The vehicle speed pulse is converted into the travel speed (absolute value) according to a certain relation. This processing is carried out on the management server 1 as described later. To obtain the more accurate value, a pulse matching module may be provided between the sensor 8 and the speedometer 80. In this case, a signal wire branches at the output side of the pulse matching module (between the pulse matching module and the speedometer), and the speed data acquisition unit 5 is connected thereto.

As shown in FIG. 4, the speed data acquisition unit 5 has an input member 51, an output member 52 outputting data including the speed data, and an output processor 53. The input member 51 includes a port to which the signal wire 82, hereafter called “speed signal wire”, is connected. The speed signal wire branches from the signal wire 81 to the speedometer 80.

The speed data acquisition unit 5 is used commonly to acquire the rotation-number pulse. A sensor detecting the rotation number is installed in the engine of the vehicle. The rotational speed pulse acquired there is displayed on a tachometer 83. Another signal wire 84 is provided branching from the wire to tachometer 83. This signal wire 84 is also connected to the speed data acquisition unit 5.

Though the system of the embodiment carries out the operation management according to the digi-tacho triple element mainly, it carries out other management together. Input ports for other signals than the speed signal are provided in the input member 51. The number of the input ports are adequately chosen from about four to eight. This embodiment has eight input ports. As shown in FIG. 4, the speed signal wire 82 is connected to port A, the rotation number pulse signal wire 84 is connected to port B, a signal wire from a refrigerator door sensor 91 is connected to port C, a signal wire from a refrigerator temperature sensor 92 is connected to port D, and the signal wire from a driver's-seat-side door sensor 93 is connected to port E. Port F-H are vacant.

The output member 52 includes a general-purpose interface circuit 521 because it transfers the data to the general-purpose terminal 4. As the general-purpose interface, USB interface including a USB port 522 is adopted in this embodiment.

The output processor 53 is to collect data from the input member 51 so that the data is output according to the general-purpose interface. For instance, the data is collected as port A:xxxx, port B:yyyy, port C:0, port D:zz, port E:0, port F:−, ports G:−, and ports H:−, and then output in a universal format, e.g., CSV. In this case, “xxxx” of port A is the vehicle speed pulse, i.e., pulse number. Port B is similarly the pulse number. “0” of port C means the refrigerator door is closed (“1” means opened). The unit of yy at the port D is ° C. because it is a temperature. “0” of the port E means the driver's-seat-side door is closed (“1” means opened). Data at the ports F-H are void.

Though there are various data transfer formats in USB, the interrupt transmission is carried out in this embodiment. The data of the universal format is output the USB port 522 periodically at constant intervals according to polling from the host side, i.e., polling from the general-purpose terminal 4 in this embodiment. When an analogue signal is input to any of the ports A-E, an AD converter is provided between the port and the output member 52 so that the signal is converted into digital and output, though signals to all ports A-E are digital in the above example.

As shown in FIG. 2, it is desirable to install the speed data acquisition unit 5 at a position not far from the mounting position of the general-purpose terminal 4, i.e., position of the terminal holder 741, because it is connected to the general-purpose terminal 4 by the general-purpose interface cable 70. The speed data acquisition unit 5 also needs to locate a position where the speed signal wire 82 is connected easily. In this embodiment, the speed data acquisition unit 5 is 1-DIN sized, considering that it is installed in a DIN space of the dashboard. However, this is not indispensable. The speed data acquisition unit 5 may be installed to any other location than the DIN space.

Though it is not shown in the figures, the speed data acquisition unit 5 has a casing in which the described members are contained. Each input port included in the input member is provided to the back side of the casing. The USB port 522 included in the output member is provided in the front side of the casing. Other than these, a required operation button such as ON/OFF switch is provided in the front side of the casing.

Next, the management server 1 is described.

The management server 1 is the server computer, on which various programs are implemented, comprising a processor (not shown) and the storage device 2. Because the management server 1 receives accesses from the general-purpose terminal 4 and the management terminal 3 via the Internet 6, it is a web server. The management server 1 is also a database server because it handles various database files. The management server 1, which is on the Internet 6, may be a server or servers in so-called cloud computing. That is, the management server 1 may be two or more servers imaginarily configuring one server on the Internet 6. The storage device 2 may be a server, i.e., storage server, provided separately from the management server 1.

The management server 1 provides a service to memorize data sent from the on-vehicle device in the storage device 2 after processing it adequately, and a service to make the data browsed in adequate windows (forms) on the management terminal 3 for the vehicle operation management. This service is hereafter called “vehicle operation management support service”. The software for the vehicle operation management support service, hereafter, vehicle operation management server software, is implemented on the management server 1. This includes a results data registration program 11 to memorize results data in the storage device 2 for registration and browse programs 13-16 to transmit the data to the management terminal 3 for browsing.

The vehicle operation management system of the embodiment is a system to carry out the operation management for commercial vehicles, e.g., vehicles of a transportation company, vehicles of a taxicab company, or vehicles for in-house logistics. Companies operating commercial vehicles are hereafter called “vehicle operating companies”. The management server 1 is usually operated by a business entity providing the vehicle operation management support service. This business entity, hereafter called “system provider”, sells or rends the speed data acquisition unit 5 to a vehicle operating company, operates the management server 1 on the Internet 6, and provides services including the vehicle operation management support service. Therefore, the system provider is a seller or render of the speed data acquisition unit 5, and the provider of the vehicle operation management support service, which may be called ASP (application service provider) and SaaS (software as a service).

Because the system provider provides the vehicle operation management system for a lot of vehicle operating companies, the management server 1 receives accesses from the management terminals 3 of the vehicle operating companies. The general-purpose terminals 4 on vehicles operated in each vehicle operating company also make accesses to the management server 1. A multiplicity of the management server may be provided, though only one is shown in FIG. 1. In this case each server may be used for each vehicle operating company respectively. Otherwise, one management server 1 may have each divided region for each vehicle operating company.

Next, the management terminal 3 is described.

As described, users of the system of the embodiment are vehicle operating companies. A vehicle operating company has a lot of commercial vehicles, and has a division in charge of the operation management. A terminal 3 for the vehicle operation management, i.e., the management terminal, is provided in this division. The management terminal 3 may be a desk-top PC or note PC placed in an office of the division. The management terminal 3 is not an element of the vehicle operation management system. The management terminal 3 corresponds to “in-office terminal” in the claim 1 in the meaning “terminal placed in an office”.

Application software to receive the vehicle operation management service, hereafter called “ope-management application”, is installed in the management terminal 3 beforehand. Though it is possible to make all software implemented on the management server 1, a part of it is installed in the management terminal 3, considering convenience for a person in charge of the management. This is the ope-management application. The ope-management application includes a program to access the management server 1 and a program to display the data transmitted from the management server 1 on a display.

Next, the vehicle operation management support service provided by the general-purpose terminal 4 and the management server 1 is described. First of all, transmission of data from the general-purpose terminal 4 to the management server 1, and data memorization on the management server 1 are described.

The general-purpose terminal 4, which is an element of the digi-tacho on-vehicle device, has one of main objects of transmitting data to the management server 1. Application software for this purpose, hereafter called “on-vehicle device application”, is installed in the general-purpose terminal 4 beforehand.

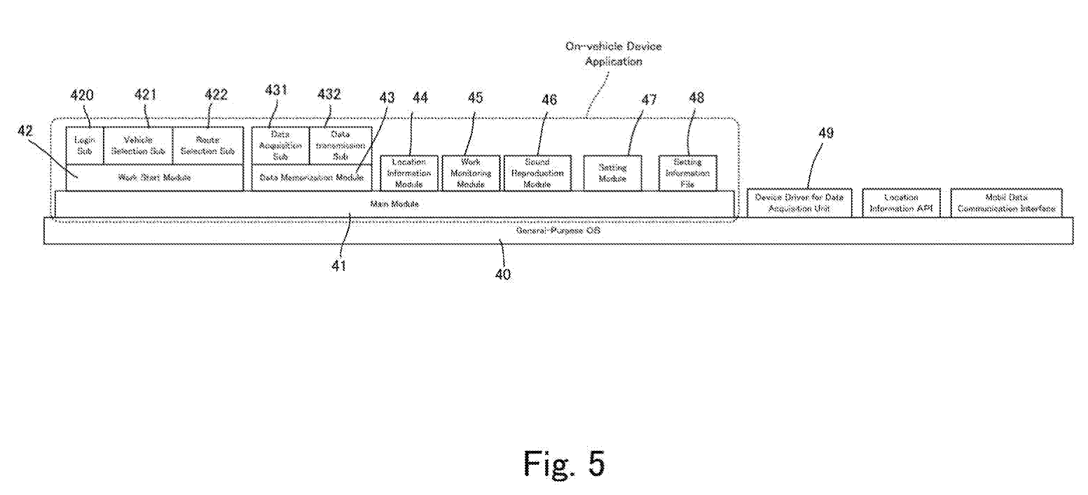

FIG. 5 schematically shows the structure of the on-vehicle device application. The on-vehicle device application is programmed by the object oriented programming, and includes program modules and data files.

As shown in FIG. 5, the on-vehicle device application is the program operable on a general-purpose OS 40 of the general-purpose terminal 4. It has a main module 41, a work start module 42, and a data memorization module 43. The data memorization module 43 is the module to acquire the speed data from the data acquisition unit 5, memorize it temporarily, collect the speed data in a certain period, and transmit it to the management server 1 for memorization. In addition, the on-vehicle device application has a location information module 44, a work monitoring module 45, a sound reproduction module 46, and a setting module 47.

The setting module 47 is the module to set various pieces of information necessary for the vehicle operation management. Information of a user using the on-vehicle device application, that is, a driver is included in the information set by the setting module 47.

As shown in FIG. 5, the on-vehicle device application includes a setting information file 48 where the setting information is recorded. The setting information includes a general-purpose terminal ID, a driver ID, and a driver name. The setting module 47 is the module to display a window in which pieces of information are input, and record them in the setting information file 48 for registration.

On the other hand, a file 21 in which user information of the on-vehicle device application is recorded, hereafter called “driver information file”, is memorized in the storage device 2 of the management server 1. The driver information file 21 is the database format file in which the described setting information is recorded for each driver ID. The driver information file 21 also has the purpose of authentication, including a field where passwords are registered beforehand.

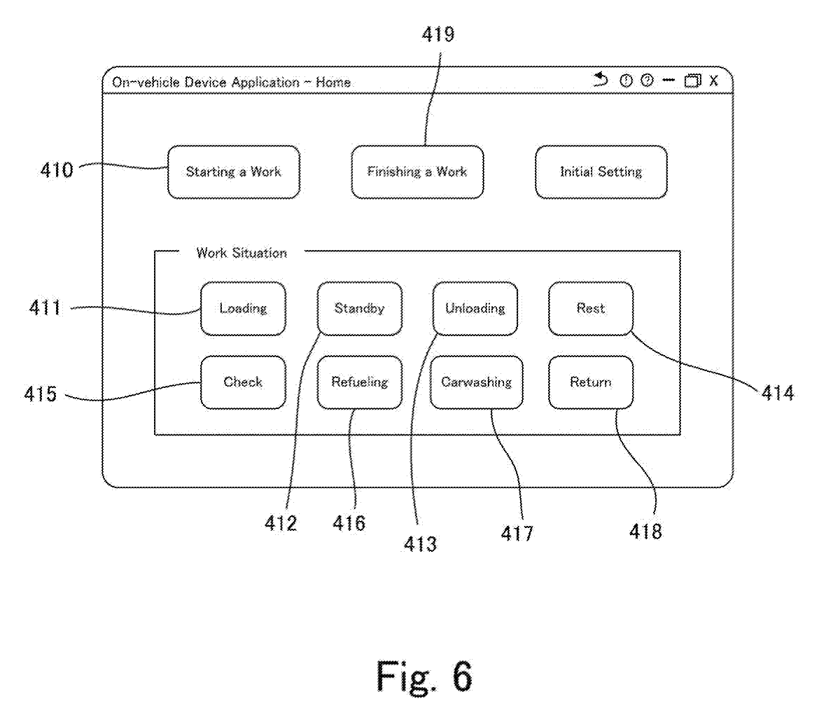

Next, the main module 41 of the on-vehicle device application is described. The main module 41 is the module to be automatically executed as the on-vehicle device application starts. The main module 41 is resident during execution of the on-vehicle device application, switching execution of other modules and switching from one window to another. FIG. 6 schematically shows one example of the man window, hereafter called “on-vehicle device main window”, displayed by the main module 41.

As shown in FIG. 6, the on-vehicle device main window includes a command button 410 captioned “Starting a Work”, hereafter called “work start button”, a command button 419 captioned “Finishing a Work”, hereafter called “work finish button”, and a command button captioned “Initial Setting”.

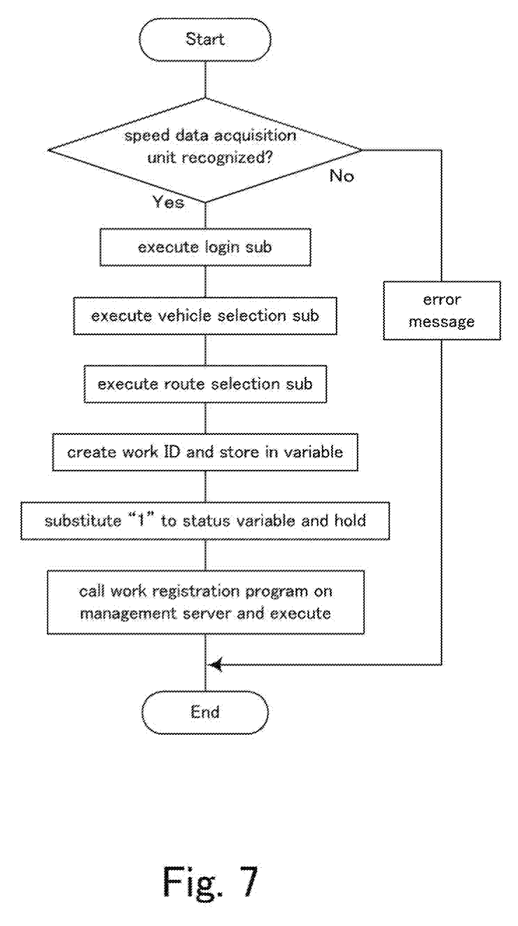

The work start button 410 is to start the work start module 42. FIG. 7 is a flow chart showing the outline of the work start module 42. As shown in FIG. 7, the work start module 42 judges whether the speed data acquisition unit 5 is recognized properly, initially after it starts. In this embodiment, the speed data acquisition unit 5 is recognized as a peripheral device of the general-purpose terminal 4. As shown in FIG. 5, a device driver 49 to use the speed data acquisition unit 5, hereafter called simply “device driver” is installed in the general-purpose terminal 4 beforehand. The setting is done so that the speed data acquisition unit 5 works properly on the general-purpose OS 40.

As described, the work start module 42 judges whether the speed data acquisition unit 5 is recognized properly by the device driver 49, initially after it starts. If it is not recognized properly, the work start module 42 returns an error message and ends.

If it is recognized properly, the work start module 42 executes a submodule 420 for login, hereafter “login sub”. The login sub 420 is the module to establish a session to the management server 1. The login program (not shown) is implemented on the management server 1. The login sub 420 executes the login program on the management server 1, specifying a certain URL of the management server 1. The login program displays an authentication window to make the driver ID and password input on the general-purpose terminal 4. A transmission button is included in the authentication window. The login program compares the transmitted driver ID and password with those in the driver information file 21. If those are correct, the login program starts a session, permitting the access to the management server 1.

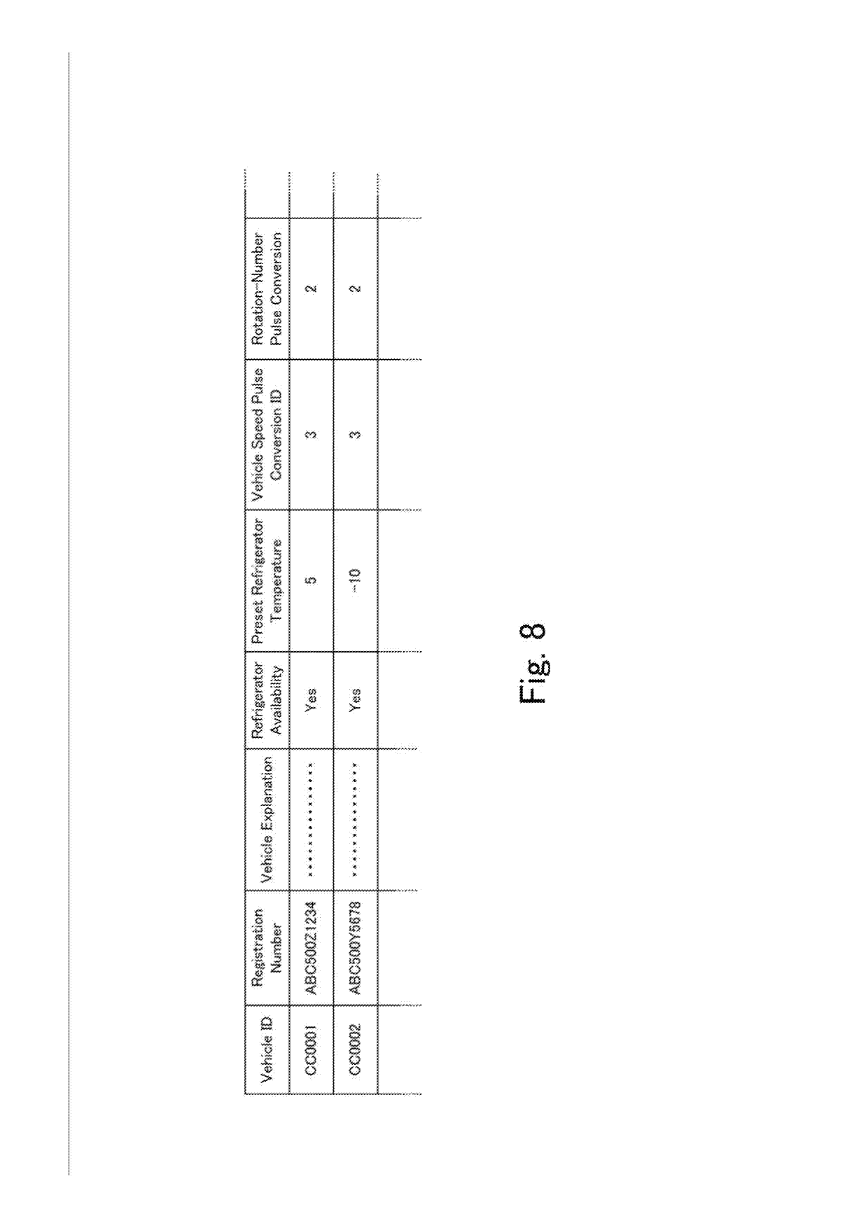

When the login is completed, the work start module 42 executes a submodule for inputting the vehicle identifiable information, hereafter called “vehicle selection sub”. A database file 22 in which information on each vehicle operated in the vehicle operating company, hereafter “vehicle information file”, is recorded is memorized in the storage device 2 of the management server 1. FIG. 8 schematically shows the structure of the vehicle information file 22 as an example.

As shown in FIG. 8, the vehicle information file 22 is a database file in which records having fields of “Vehicle ID”, “Registration Number”, “Vehicle Explanation”, “Refrigerator Availability”, “Preset Refrigerator Temperature”, “Vehicle Speed Pulse Conversion ID” and “Rotation-number Pulse Conversion ID” are recorded. The number of the records corresponds to the number of the vehicles.

The number of the numberplate of a vehicle is recorded in “Registration Number”. “Vehicle Explanation” is the field where explanation of a vehicle is input as a string. “Preset refrigerator temperature” is the field to set a threshold for refrigerator temperature. When the refrigerator temperature in a vehicle exceeds the threshold, it is judged as abnormal. Because the threshold may be different depending on vehicles, it is managed on the database. “Vehicle Pulse Conversion ID” is the ID to choose a conversion formula in converting the vehicle speed pulse. “Rotational Speed Pulse Conversion ID” is the ID to choose a conversion type in converting the rotational speed pulse.

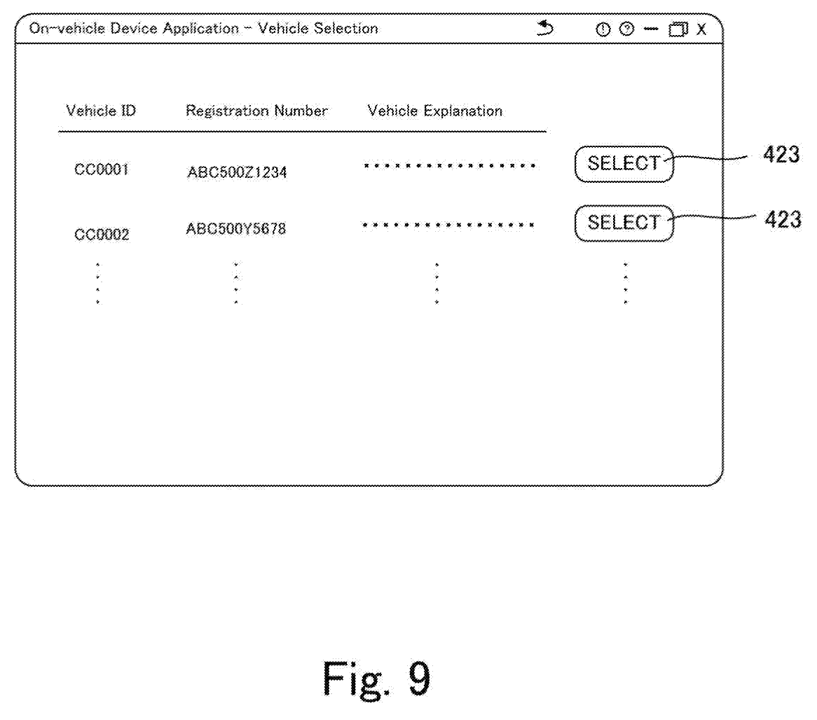

The vehicle selection sub 421 displays a window for vehicle selection, hereafter “vehicle selection window”, on the general-purpose terminal 4 when it starts. FIG. 9 schematically shows one example of the vehicle selection window. In the vehicle selection window, information of all vehicles being operated in a vehicle operating company is displayed as a list. The vehicle selection sub 421 is programmed so as to acquire the information from the vehicle information file 22 on the management server 1, and to display it in the vehicle selection window.

A command button 423 captioned “Select”, hereafter “selection button”, is provided at the right end of each line in the list. When a selection buttons 423 on any line is tapped, the vehicle of the line is selected. The vehicle selection sub 421 temporarily stores the vehicle ID of the selected vehicle in a variable.

Preferably, the vehicle ID selected in the last-time execution of the on-vehicle device application has been memorized on the general-purpose terminal 4 or on the management server 1, and is displayed on the top of a list when the vehicle selection window is displayed, because a driver often carries out every work using the same vehicle. Otherwise, a checkbox captioned “same as last time” may be provided. The same vehicle ID as in the last time work is stored in the variable by checking it.

After the login and selection of the vehicle ID as described, the work start module 42 executes a submodule to make a traveling route selected, hereafter “route selection sub”. In the storage device 2 of the management server 1, a route information file 23, in which information on transportation routes for each vehicle operating company is recorded, is memorized. Though not shown in the figures, the route information file 23 is a database file where each record having fields of “Route ID”, “Route Name”, and “Dangerous-Points Information File Name” is recorded for each route.

A dangerous-points information file 24 is memorized in the storage device 2 of the management server 1, corresponding to each record in the route information file 23. Each dangerous-points information file 24 is provided for each route. It is a database file where records having fields such as “Dangerous-Points Location Information (numeral)” and “Dangerous-Points Location Information (text)” are recorded. The number of the records corresponds to the number of dangerous points. In those, “Dangerous-Points Location Information (numeral)” is the field to record latitude-longitude information, e.g., GPS, of dangerous points in a route. “Dangerous-Points Location Information (text)” is the text field for describing dangerous points.

The route selection sub 422 is programmed so as to open the route information file 23 for the vehicle operating company according to the driver ID, to display a name list of routes in a route selection window (not shown), and to make one of them selected. As a result of the selection, the route ID of the route is stored in a variable on the on-vehicle device application.

When the vehicle ID and the route ID are stored in the variables respectively as described, the work start module 42 newly and automatically creates the work ID and stores it in another variable. The work ID is created for a specific driver's work in a day or work at one time, i.e., for every unit of the vehicle operation management. As an example, it is automatically created according to the driver ID and the system-date-and-time when the work start button 410 is tapped. For instance, “AA0001-201410010900” is created when the work ID of a driver ID is “AA0001”, and when the work start button 410 was tapped at 9:00 AM on Oct. 1, 2014. The work ID is held in the variable during execution of the on-vehicle device application.

As shown in FIG. 7, after creating and storing the work ID the work start module 42 substitutes “1” meaning on duty (driving) to a variable for judging work situation. This variable is hereafter called “state variable”. A value of the state variable depends on work situation in the operation. “0” means off duty, i.e., after a work has finished and before next work does not start.

As described later, on the other hand, a work registration program 12 is implemented on the management server 1. The work registration program 12 is called from the work start module 42 to be executed, and carries out such processing as addition of a new record to a work information file 25 and addition of a new record to the results data file 26.

As shown in FIG. 7, the work start module 42 executes the work registration program 12 on the management server 1 after carrying out a login, vehicle selection, route selection, update of the state variable in order. The work start module 42 ends when a value meaning the proper completion of the work registration program is returned from the management server 1.

Next, the work monitoring module 45 is described. The work monitoring module 45 is the module to monitor driver's work situation for the management. In this embodiment, the work monitoring module 45 is the module which monitors the work situation by transmitting to the management server 1 both the information input on the general-purpose terminal 4 by a driver and the outputs from devices installed in the vehicle.

As shown in FIG. 6, concretely, a frame for the work monitoring is provided in the on-vehicle device main window. Several command buttons 411-419 for the work monitoring, hereafter “work monitoring buttons”, are provided in this frame. In this example, eight work monitoring buttons 412-419 captioned respectively “Loading”, “Unloading”, “Rest”, “Check”, “Refuel”, “Carwash”, and “Return” are provided.

When a work is started as the work ID is given, “1” meaning on-duty, i.e., driving is substituted to the state variable. The work monitoring module 45 changes the value of the state variable according tapping of each work monitoring button 411-419. For instance, the value is allocated according to each state as shown below.

### Driving: 1

### Loading: 2

### Standby: 3

### Unloading: 4

### Rest: 5

### Check: 6

### Refueling: 7

### Carwash: 8

### Return: 9

When the button “Loading” is tapped, for instance, the work monitoring module 45 changes the state variable to “2”. When the button “Standby” is tapped, the work monitoring module 45 changes the state variable to “3”. For other buttons, the value is changed similarly. “Standby” means a driver is on standby for loading or unloading.

Thus, the state variable to be changed according to tapping of the work monitoring buttons 411-419 is transmitted to management server 1 with the speed data by the data transmission sub 432 of the data memorization module 43 as described later. Those are utilized for the vehicle operation management via the management server 1.

Next, the location information module 44 is described. The location information module 44 is the module to notify the current location of a vehicle to the management server 1 by using location notification function of the general-purpose terminal 4.

A location notification function such GPS is implemented on almost all mobile general-purpose terminals on sale, e.g., tablet PCs and smartphones. API operable under a general-purpose OS such as Android, iOS and Windows8 for location notification is available for developers. The location information module 44 is the module to acquire the location information by using the location notification API on the OS installed in the general-purpose terminal 4, and stores it in a variable in the on-vehicle device application, hereafter “location information variable”. The stored location information is the information at the moment when the location information module 44 is started.

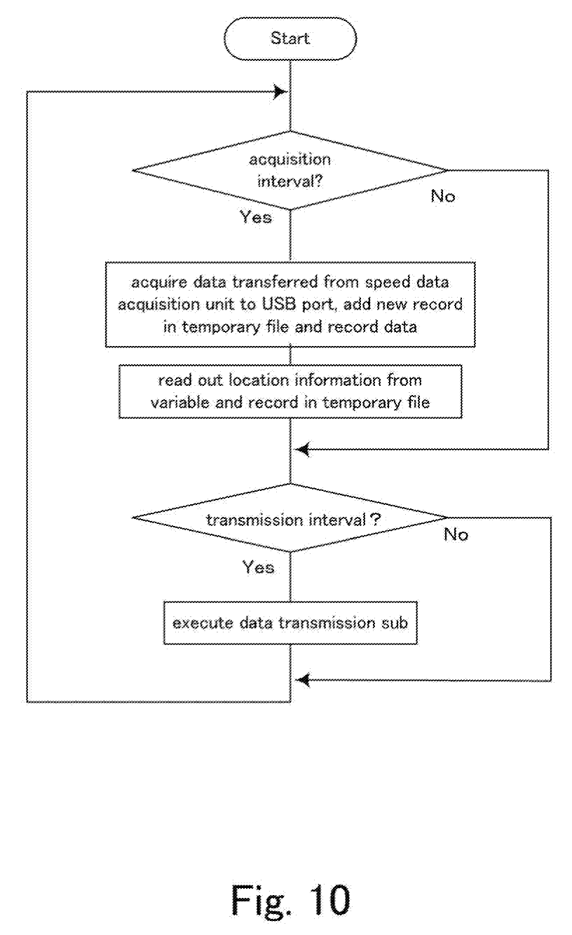

Next, the data memorization module 43 is described. FIG. 10 schematically shows a flow chart of the data memorization module 43. Roughly, as shown in FIG. 10, the data memorization module 43 is the module which executes a submodule 431 for the data acquisition, hereafter “data acquisition sub”, and parallelly executes a submodule 432 for the data transmission, hereafter “data transmission sub”, at constant intervals. The data acquisition sub 431 is the module that is resident and executed as far as the state variable is not “0” after the work start module 42 starts.

The data acquisition sub 431 is the module to acquire the speed data from the data acquisition unit 5 via the USB interface. The data acquisition sub 431 accesses the speed data acquisition unit 5, and makes it carry out interrupt transfer of the data stored in the output member thereof. The interval of transfer is preset on the device driver 49. It is adequately preset within the range of, for instance, about 5 ms-100 ms, hereafter “device interval”.

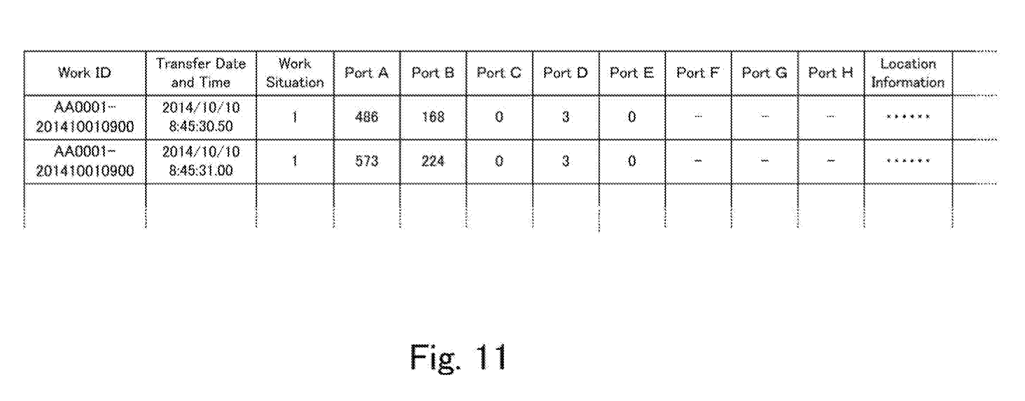

As shown in FIG. 5, the on-vehicle device application includes a file 48 to record the data temporarily, hereafter “temporary file”. FIG. 11 schematically shows one example of the structure of the temporary file. The temporary file has a universal database format such as CSV. As shown in FIG. 11, the temporary file has a field “Work ID”, a field “Transmission Date and Time”, fields to which the data from the ports A-H is recorded, a field “Work Situation”, and a field “Location Information”.

The data is transmitted from the speed data acquisition unit 5 at every device interval preset on the device driver 49. If it is intended to acquire the speed data most frequently, the data can be acquired at every device interval. However, this is not preferable because the data volume increases too much. Therefore, the speed data is acquired at an interval longer than the device interval usually. This interval is hereafter called “acquisition interval”. The acquisition interval is, for instance, 0.5 seconds. Though a new data is transferred at every device interval to the USB port of the general-purpose terminal 4 and updates the variable, the data acquisition sub 431 acquires the data from the USB port at every acquisition interval of 0.5 seconds longer than the device interval, adds a new record in the temporary file, and records it therein.

The data acquisition sub 431 memorizes the value of the state variable in the field “Work Situation” of the temporary file at the moment when it reaches the acquisition interval.

The data acquisition sub 431 also reads out the value stored in the location information variable at that time, which is the execution result of the location information module 44, and memorizes it in the field “Location Information”.

As shown in FIG. 10, while the data acquisition sub 431 is executed, the data acquisition sub 431 executes the data transmission sub 432 at every constant interval, hereafter “transmission interval”. The transmission interval is, for instance, ten minutes.

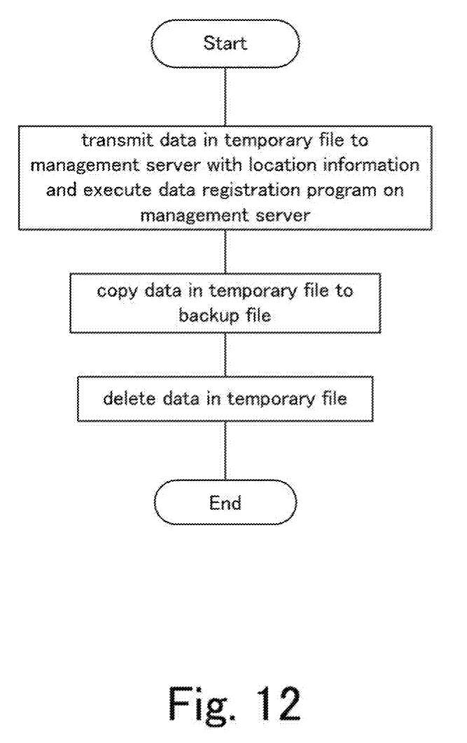

FIG. 12 schematically shows a flow chart of the data transmission sub 432. As shown in FIG. 12, the data transmission sub 432 initially transmits contents of the temporary file, i.e., all records recorded in the temporary file at that time, with the location information to the management server 1. In this, the data to be transmitted is a universal format data such as SCV. Concretely, the data transmission sub 432 calls the results data registration program 11 implemented on the management server 1, pass the data thereto, and execute it.

Next, the data transmission sub 432 copies all records in the temporary file to a backup file, and then deletes all records therein, making the number of records to be zero. The backup file is a database file that has a structure similar to the temporary file and is memorized in such a storage device as hard disk in the general-purpose terminal 4. The data transmission sub 432 ends by carrying out the data transmission to the management server 1 and the data export to the backup file.

Though explanation was omitted for the backup file, it is newly made when the work start module 42 starts. The file is named using the work ID so that it can be found out by specifying the work ID.

Next, the sound reproduction module 46 is described.

The sound reproduction module 46 is the module that enables reproduction of a sound file transmitted from the management server 1. For this, a sound reproduction API is implemented in the on-vehicle device application. As described later, the sound file may be transmitted to the general-purpose terminal 4 by manipulation from the management terminal 3, while the inspection-monitoring program 14 or the safety management program 16 is executed on the management server. The sound reproduction module 46 is the module to reproduce this sound file on the on-vehicle device application to announce a voice message to the driver.

Next, each of programs and files on the management server 1 is described.

The work registration program 12 is implemented in the management server 1, corresponding to the work start module 42 of the on-vehicle device application as described. The results data registration program 11 is implemented corresponding to the data transmission sub 432 of the data memorization module 43 in the on-vehicle device application.

First of all, the work registration program 12 is described. The work registration program 12 is the program that is called and executed by the work start module 42 as described, and carries out new record addition in the work information file 25 and new record addition in the results data file 26.

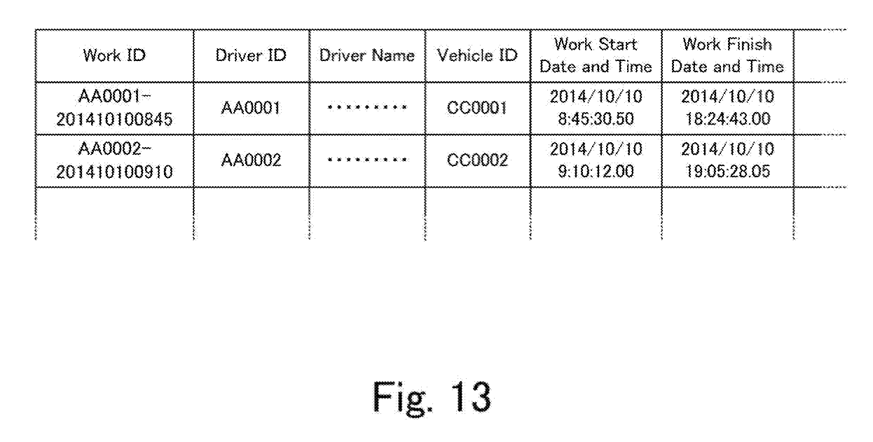

The work information file 25 is described referring to FIG. 13. FIG. 13 shows the structure of the work information file 25 as an example. As shown in FIG. 13, the work information file 25 is the database file where a lot of records having fields such as “Work ID”, “Driver ID”, “Driver Name”, “Vehicle ID”, “Work Start Date and Time”, and “Work End Date and Time” are recorded.

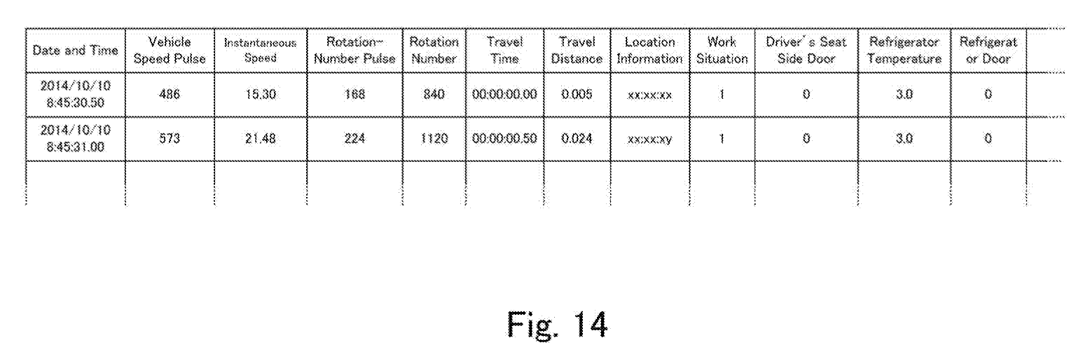

Next, the results data file 26 is described referring to FIG. 14. FIG. 14 is a schematic view showing the structure of the results data file 26.

The results data file 26 is newly created when the work ID is newly given by the work start module 42 as well. The results data file 26 is usually named using the work ID. As shown in FIG. 14, the results data file 26 is the file where a lot of records having fields of “Time”, “Travel Time”, “Travel Distance”, “Instantaneous Speed”, “Location Information”, and “Work Situation” are recorded.

The work registration program 12 adds a new record in the work information file 25, and records each piece of information in each field when it is called and executed by the work start module 42. The work start module 42 is executed, receiving the work ID, the driver ID, and the vehicle ID, which have been stored in the variables, as arguments. The work registration program 12 records these piece of information in fields of “Work ID”, “Driver ID”, and “Vehicle ID” in the added record. Date and time when the work registration program 12 starts are recorded in the field “Work Start Date and Time”.

The results data file 26 is newly created under a filename using the work ID, and memorized in the storage device 2. The created results data file 26 is left opened, into which a record can be added. The work registration program 12 ends with this status.

The results data registration program 11 is called and executed by the data transmission sub 432 of the on-vehicle device application at every transmission interval as described. The results data registration program 11 is executed with the work ID as an argument. The results data registration program 11 is programmed so as to add one record in the results data file 26, and to record a value in each field in the added record for registration. The results data registration program 11 records the value of “Transmission Date and Time” of the temporary file to the field “Time”, records the value of the vehicle speed pulse that is the data of port A to the field “Vehicle Speed Pulse”, records the value of the rotation-number pulse that is the data of port B to the field “Rotation-Number Pulse”, records the data of port C to the field “Refrigerator Door”, records the data of port D to the field “Refrigerator Temperature”, and records the data of port E in the field “Driver's Seat Side Door”. The results data registration program 11 records the value of the field “Temporary Information” in the temporary file to the field “Location Information”.

The results data registration program 11 is programmed so as to calculate the instantaneous speed and the rotation number, and to record them in the results data file 26. Concretely, absolute value of the speed at one pulse differs depending on vehicle manufacturers, though the number of pulse corresponds to the travel speed of the vehicle. As shown in FIG. 8, the field “Vehicle Speed Pulse Conversion ID” is provided in the vehicle information file. The results data registration program 11 acquires the vehicle ID from the work information file according to the work ID, and acquires the vehicle speed pulse conversion ID for the vehicle. Thus, the results data registration program selects the conversion type according to the vehicle speed pulse conversion ID, and calculates the spontaneous speed from the transmitted vehicle speed pulse.

Though the specification of the rotation-number pulse does not differ depending on vehicle manufacturers so much, the rotation-number is calculated by applying the conversion formula selected according to the vehicle ID as well. The results data registration program 11 is programmed so as to acquire the value of the field “Rotation-Number Pulse Conversion ID” in the vehicle information file, to select the conversion formula of the rotation-number pulse, and to calculate the rotation number according to the selected conversion formula.

In the system of this embodiment, as described, the speed data acquired in the speed data acquisition unit 5 is transmitted to the management server 1 via the general-purpose terminal 4, and each piece of data is recorded in the results data file 26 in the storage device 2 by the results data registration program 11 as the instantaneous speed and the rotation number are calculated.

When the general-purpose terminal 4 is a tablet PC, it is preferably a cellular type. A Wi-Fi type one is used with a Wi-Fi router, which only has limited access points. Therefore, the Wi-Fi type is not so suitable for connecting permanently to a server as in the embodiment.

Each piece of the information recorded in the results data file 26 is browsed on the management terminal 3 for the vehicle operation management. Programs 13-16 for browsing are implemented on the management server 1 as elements of the vehicle operation management support service. Next, these programs 13-16 for browsing are described.

In the management server 1, as shown in FIG. 1, the triple-element browse program 13 to browse the digi-tacho triple element data, the inspection-monitoring program 14 to browse information on vehicle inspection and work monitoring, the eco-evaluation program 15 to browse information on eco-driving evaluation, and the safety management program 16 are implemented.

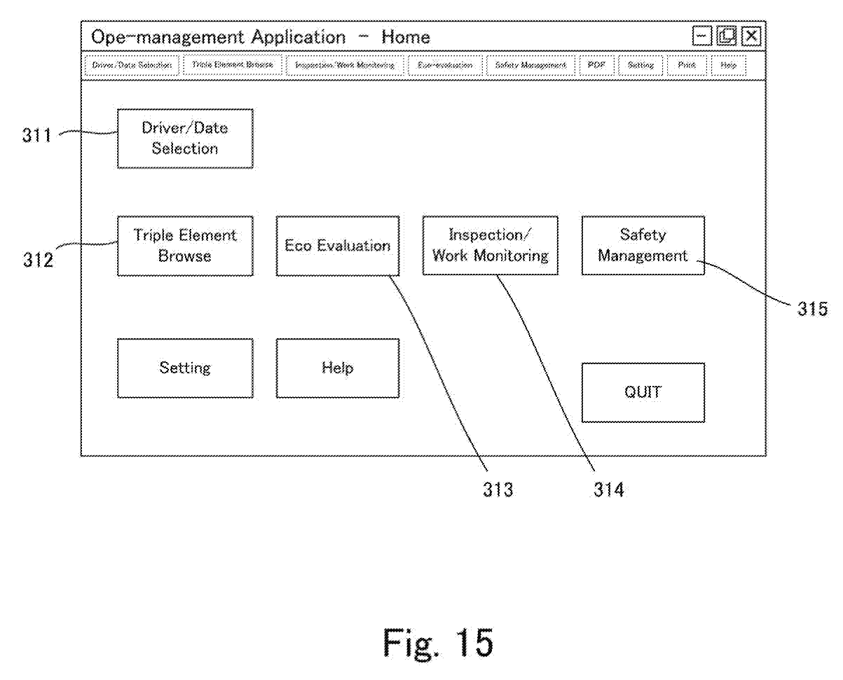

The ope-management application is installed beforehand in the management terminal 3 as described. The ope-management application is provided to the vehicle operating company in advance, and installed in the management terminal 3. FIG. 15 schematically shows one example of an initial window, hereafter “application top window”, displayed on the management terminal 3 by the ope-management application.

Though it is not shown in the figures, a login to the management server 1 is carried out automatically when the ope-management application is started on the management terminal 3. The office ID is issued beforehand to the vehicle operating company, and the person-in-charge ID is issued to a person in charge of the management in the vehicle operating company. In the storage device 2 of the management server 1, an office information file (not shown) where the office information is recorded, and a person-in-charge information file (not shown) where the information on each person in charge of the management in each office is memorized. The ope-management application makes the office ID, the person-in-charge ID and the password input in the login window and transmitted, and compares the input pieces of information with the information in the office information file. When those are correct, a login is permitted, establishing a session to the management server 1. After the login the application top window shown in FIG. 15 is displayed on the management terminal 3.

In the application top window, as shown in FIG. 15, a button 311 captioned “Driver/Date Selection”, hereafter “work selection button”, a button 312 captioned “Triple Element Display”, hereafter “triple element browse button”, a button 313 captioned “Inspection/Work-Monitoring”, hereafter “inspection-monitoring button”, a button 314 captioned “eco-evaluation”, hereafter “eco-evaluation button”, and a button 315 captioned “Safety Management”, hereafter “safety management button” are provided.

The work selection button 311 is the button to select a work to be managed. A driver information file 21 in which the driver information is recorded is memorized in the storage device 2 of the management server 1 as shown in FIG. 1. The driver information file 21 is provided for each office, i.e., one file for one office ID. The driver information file 21 is the database file where the driver name and the driver ID of drivers belonging to the office are recorded.

The work selection program 17 on the management server 1 starts when the work selection button 311 is tapped. The work selection program 17 displays a work selection window, which includes a driver selection box and a data selection box, on the management terminal 3. The work selection program 17 stores the selected driver ID of a driver and the selected date to variables temporarily.

The work selection program 17 searches the work information file 25 by the selected driver ID and the selected date, finds the corresponding record, makes it active, and reads out the work ID therefrom. Thus, the work selection program 17 temporarily stores the work ID in a variable.

When the triple element browse button or another is tapped as no work ID is stored in the variable, the error message “Please select Driver/Date first” is displayed, asking the person in charge of the management to specify a work.

On the other hand, the triple element browse button 312 shown in FIG. 15 is an execution button of the triple element browse program 13. The triple element browse program 13 reads out the work ID from the variable, and opens the results data file 26 having a filename corresponding to the work ID. The triple element browse program 13 is programmed so as to read out data in each record of the results data file 26, processes the data adequately, lay the processed data in a window for browsing, hereafter “triple element browse window”, transmit the window and the data to the management terminal 3, and make them displayed thereon.

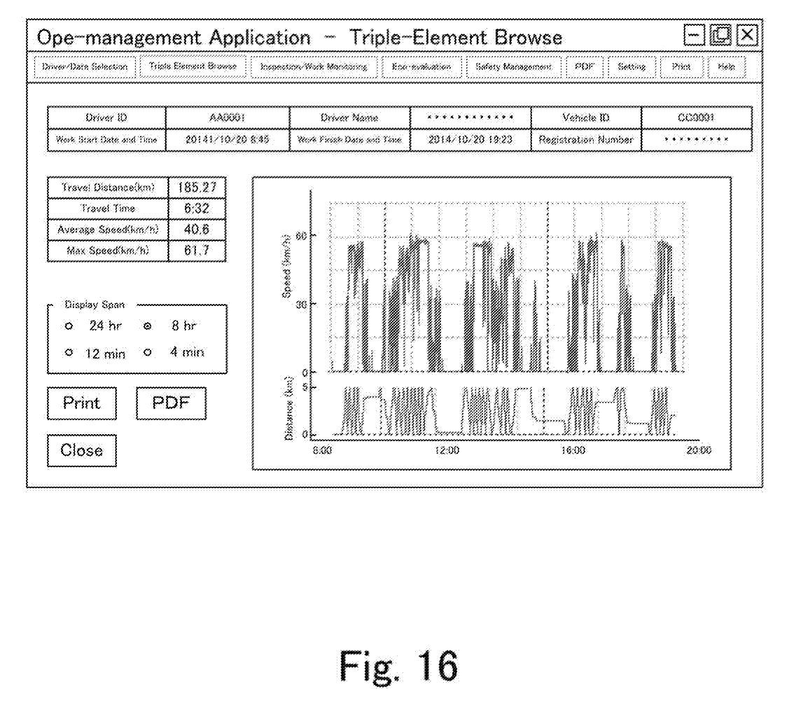

FIG. 16 schematically shows one example of the triple element browse window displayed on the management terminal 3. As shown in FIG. 16, the triple element browse program 13 displays a graph of the triple element. In this example, a graph of speed against time, and a graph of distance against time are displayed up and down. The graph of distance against time is turning back at 5 km. Because the data processing to display these graphs is easy for those skilled in the art, detailed description is omitted.

For the axis of time, 24 hours, 8 hours or another span can be chosen as shown in FIG. 16, enabling graphing in the chosen span. When a narrow span is selected, a scrollbar is displayed in the graph frame, being scrolled adequately.

As time information in the triple element, each absolute time in the travel distance and each absolute time in the instantaneous speed may be displayed in addition to relative time after the departure, i.e., the travel time.

Next, the inspection-monitoring program 14 is described. The inspection-monitoring program 14 is the program to check the status of the vehicle according the data transmitted from the general-purpose terminal 4, and to monitor a driver's work. The inspection-monitoring program 14 starts when an inspection-monitoring button 313 shown in FIG. 15 is tapped.

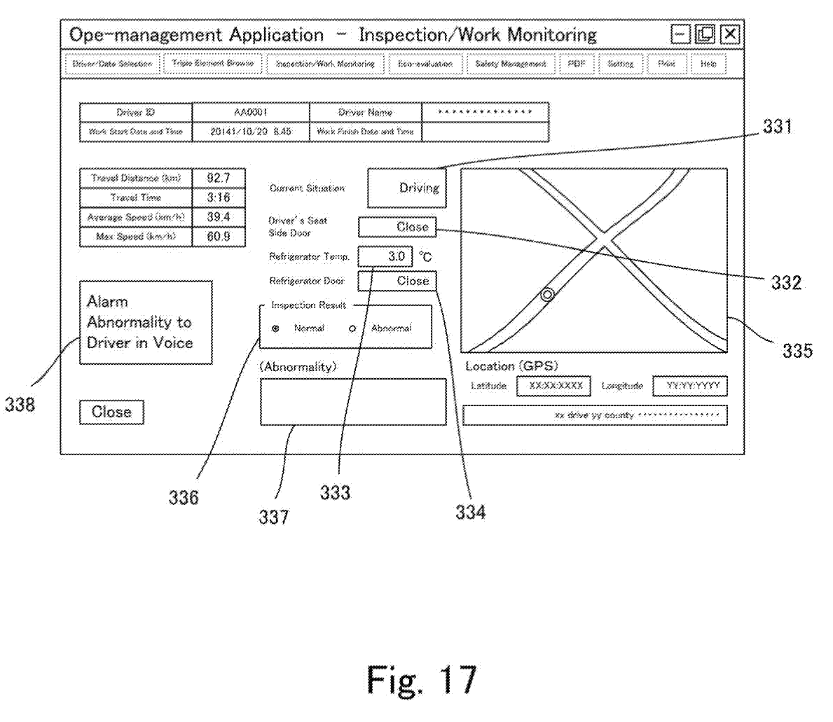

FIG. 17 schematically shows one example of a window, hereafter “inspection-monitoring window”, displayed on the management terminal 3 by the inspection-monitoring program 14. The inspection-monitoring program 14 is executed after a work is selected, i.e., after the work ID is stored in the variable. If not selected, an error message is displayed as well, asking the selection. Inspection and work monitoring are the basic elements of the vehicle operation management while a work is carried out. A button captioned “Today” is included in the work selection window. When this button is tapped, works being carried out on that day are displayed in a list, from which a work, i.e., driver, is selected.

As shown in FIG. 17, information on the driver and the work start date-and-time for the selected work ID is displayed in the inspection-recognition window. These pieces of information are acquired from the work information file 25 according to the work ID. The travel time, the travel distance and others are displayed as well. These pieces of information are calculated on the basis of the data acquired from the results data file 26 according to the work ID, and then displayed. Because the work is being carried out usually, the data is the one just at the point of time when displayed, i.e., just when the inspection-monitoring program 14 is started.

As shown in FIG. 17, a box 331 to display driver's current situation, hereafter “current situation box”, is provided in the middle of the inspection-monitoring window. The inspection-monitoring program 14 is programmed so as to read out the value of the field “Work Situation” in the latest record of the results data files 26, and display it as text in the current situation box 331 according to the described correspondence relationship. Therefore, this box 331 basically depends on the result of tapping by the driver on the general-purpose terminal 4, i.e., just on the driver's report.

Still, display of the current situation box 331 may be carried out on the basis of the results that the program has judged logically from values of other fields in the results data file 26. For instance, it is programmed so as to display “driving” in the current situation box 331 as far as the value of the field “Work Situation” is “1”, and the value of the field “Instantaneous Speed” is more than a threshold. In this example, an error message is displayed in the current situation box 331 when the value of the field “Instantaneous Speed” is below the threshold. Otherwise, the situation may be judged only by the value of the field “Instantaneous speed”, and then displayed.

A box 332 to display the open/close status of a driver's-sheet-side door, a box 333 to display refrigerator temperature, and a box 334 to display the open/close status of the refrigerator door are provided below the current situation box 331. For these boxes 332-334 as well, the inspection-monitoring program 14 is programmed so as to read out the values from the fields of “Driver's-Seat-Side Door”, “Refrigerator Temperature”, and “Refrigerator Door” in the latest record of the results data file 26, and display them. Because “0” means “close”, and “1” means “open” for the values of the fields “Driver's Seat Side Door” and “Refrigerator Door”, those are converted as such and then displayed.

A map box 335 to display current location of a vehicle in a map is provided at the right to the current situation box 331. The inspection-monitoring program 14 is programmed so as to acquire the location information from the field “Location Information” of the latest record in the results data file 26, and to display the location with a special mark, “CD” in this example, in the map. In this, a map configuration data is separately acquired according to the location information from another database. This database is preferably constructed in another server than the management server 1 because the file size becomes huge. The map configuration data may be acquired from a server of another company.

A box to display the location information as latitude and longitude is provided below the map box 335. The location information acquired from the results data file 26 is displayed in this box as it is. Below this box, a box to display information of the current location as text is provided. Information in this box is usually acquired from a server providing the map configuration data. This kind of server has a database to express a current location as text corresponding to latitude and longitude, being capable of providing the current location information as text. The inspection-monitoring program 14 is programmed to so as to put the information by using this service.

As shown in FIG. 17, a box 336 captioned “Inspection Result”, hereafter “inspection result display box”, is provided at the lower middle position in the inspection-monitoring window. Either of lamps “Normal” and “Abnormal” is made on here (expressed metaphorically though strictly any checkbox is checked). The inspection-monitoring program 14 has a module to inspect the current situation of a vehicle from the value of each record in the results data file 26, hereafter “inspection module”.

The inspection module is the module to make an inspection result by judging some factors according to the value of each field in the results data file 26. Inspection is carried out for several items, judging normal or abnormal on each item. The inspection module is programmed so as to make the lamp “abnormal” on when any item is judged abnormal, and otherwise make the lamp “normal” on.

If the value of the field “Driver's Seat Side Door” is false, i.e., the door is open, for instance, it is judged abnormal when the value of the state variable is “1” meaning “Driving”, otherwise judged normal.

If the value of the field “Refrigerator Door” is false, i.e., open, it is judged abnormal when the value of the state variable is “2” meaning loading or “4” meaning unloading, and otherwise judged abnormal.

For the value of the field “Refrigerator Temperature”, the refrigerator temperature threshold is acquired when the inspection-monitoring program 14 is started, enabling the judgment of the normality. The Inspection-monitoring program 14 searches the work information file 25 by the work ID stored in the variable, and acquires the vehicle ID from the corresponding record. The inspection-monitoring program 14 acquires the refrigerator temperature threshold from the vehicle information file 22. When the value of the field “Refrigerator Temperature” is below the threshold, it is judged normal, and otherwise judged abnormal.

As shown in FIG. 17, the inspection-monitoring window has a box 337 to alarm abnormality, hereafter “abnormality notification box”. The abnormality notification box 337 is a text box. The inspection module is programmed so as to display a string to alarm the abnormality in the abnormality notification box 337 when it is judged in an inspection result. The string here has been preset so as to form a sentence for each inspection item in the module. For instance, it is like “Refrigerator temperature exceeds the proper range. Please check it.”

In addition, a command button 338 captioned “Alarm Abnormality to Driver in Voice”, hereafter “voice notification button”, is provided lower left in the inspection-monitoring window. Corresponding to this, the inspection-monitoring program 14 has the voice notification module.

The voice notification module is the module to alarm abnormality to a driver by a voice message when any abnormality is judged in the inspection module. Though the voice notification module is the program on the management server 1, the on-vehicle device application on the general-purpose terminal 4 includes the sound reproduction module 46 as described.

A sound file for the abnormality notification on each inspection item is memorized in the storage device 2 of the management server 1. The voice notification module is programmed so as to select a sound file according to the item judged abnormal in the inspection module, and to transmit it to the general-purpose terminal 4. The voice notification module acquires the IP address (static IP address) of the general-purpose terminal 4 from the environment variable stored in the login session, and executes the sound reproduction module 46 of the on-vehicle device application resident on the terminal of this IP address.

The sound reproduction module 46 is programmed so as to display transmission of a sound file (abnormality alarming message) in a window on the general-purpose terminal 4, and to reproduce the transmitted sound file from a speaker thereof.

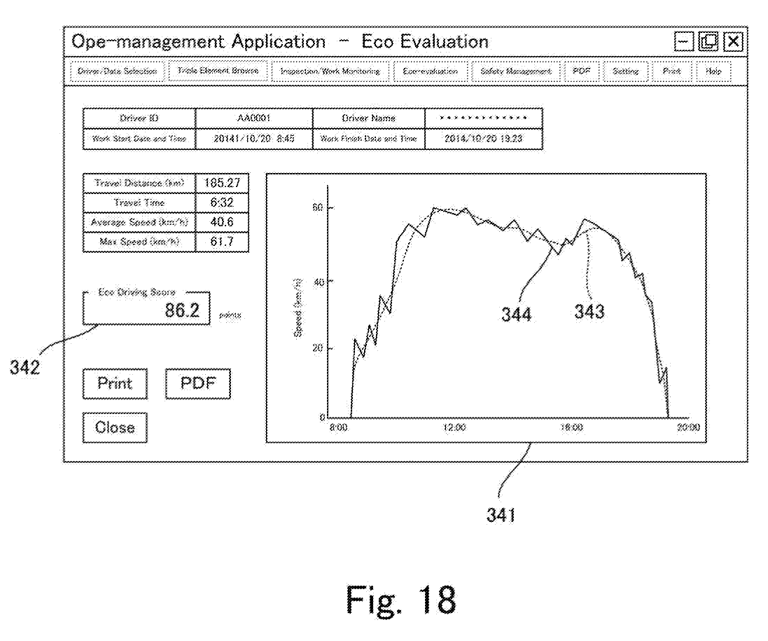

Next, the eco-evaluation program 15 is described. FIG. 18 schematically shows one example of a window displayed on the management terminal 3 by the eco-evaluation program 15, hereafter “eco-evaluation window”. As shown in FIG. 18, the eco-evaluation window includes a box 341 to display a graph concerning eco-evaluation, hereafter “graph box”, and a box 342 to display the score of eco-evaluation, hereafter “score box”.

The eco-evaluation program 15 is the program to evaluate how much attention is paid for eco-driving in the vehicle operation, and make a result of it browsed. Concretely, the eco-evaluation program 15 draws an ideal standard travel-speed curve on the basis of the results data transmitted from the general-purpose terminal 4, and carries out the eco-evaluation according to degree of the deviation from the curve.

Whether it is eco-driving, i.e., driving paying attention to the environment, or not is simply known from the amount of the CO2 exhaust (the amount of exhaust gas). In this case, the amount of exhaust gas increases when rapid acceleration and sudden deceleration are unnecessarily repeated, which are not recognized as eco-driving. Unnecessary rapid accelerations and unnecessary sudden decelerations are done often when the distance to a preceding vehicle is short. Rapid acceleration and sudden deceleration would be done more frequently if a driver intends to follow without the enough distance to the preceding vehicle. If the enough distance to the preceding vehicle is maintained, rapid acceleration and sudden deceleration would be done less frequently, and the amount of exhaust gas would decrease even in the same travel distance. Decrease of the exhaust gas amount means decrease of the fuel consumption amount. This brings the merit of cost reduction to the vehicle operating company. In view of preventing traffic accidents as well, it is desirable to drive keeping the enough distance to a preceding vehicle.

For instance, JP3944549B discloses the technique to obtain a smooth curve (standard speed curve in this example) by the Fourier transform of a vehicle speed graph data (time vs. speed), thereby carrying out eco-evaluation. The technique disclosed in this reference may be used. Otherwise, it is possible to obtain the standard speed curve by specifying sharp points in a speed graph, i.e., a time point where the speed changes more than a certain extent, calculating the mean speed around each sharp point, and putting a line through the points of the calculated mean speed.

Anyway, the standard speed curve can correspond to the speed graph for ideal driving without (or with possibly reduced) rapid accelerations and sudden decelerations. The eco-evaluation program 15 compares the standard speed curves obtained by one of the described method to a speed curve obtained from the original results data, and calculates deviation. Then, the eco-evaluation program 15 calculates the score of the eco-evaluation according to the amount of deviation. Of course, lesser deviation gains a higher score. As shown in FIG. 18, the eco-evaluation program 15 is programmed so as to display a speed curve 344 of the results data and a calculated standard speed curve 343 in the graph box, and to display the score of the calculated eco-evaluation in the score box 342.

The eco-evaluation may be carried out considering the data of fuel consumption. The data of fuel consumption is usually acquired by the fill-up method. That is, a tank is always filled up with fuel. The amount of fuel put into the tank at a time of refilling corresponds to the amount of fuel consumption from the last time of refilling. The average fuel efficiency is calculated from the relationship of the fuel consumption amount and the integrated travel distance in the mean time, which may be eco-evaluation for the vehicle or the driver. To enable such management, the storage device 2 memorizes a database file in which the refueling data of each vehicle, i.e., refueling date and amount of refueling, is recorded is memorized, and a program to memorize the amount of refueling via the general-purpose terminal 4 is implemented on the management server 1.

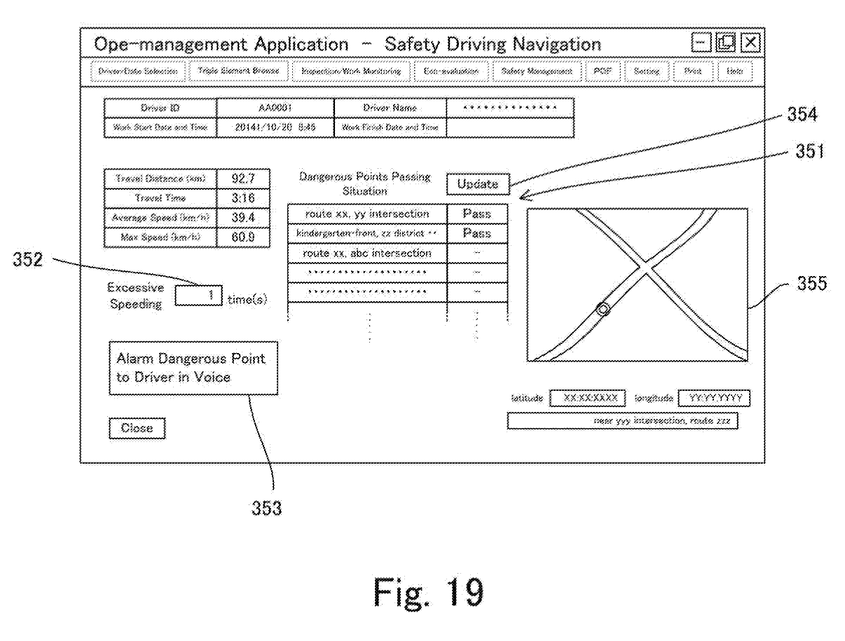

Next, the safety management program 16 is described. FIG. 19 schematically shows one example of a window displayed on the management terminal 3 by the safety management program 16, hereafter “safety management window”.

As shown in FIG. 19, the safety management window has a box 351 to display passing situation through dangerous points, hereafter “passing situation box”, and a box 352 to display the number of times of excessive speeding, hereafter “excess time box”.

The safety management program 16 is programmed so as to display a list of the dangerous points and passing situation through the dangerous points in the passing situation box 351. Concretely, the safety management program 16 searches the work information file 25 by the work ID stored to the variable, acquires the route ID, and acquires the name of the dangerous-point information file corresponding to the route ID from the route information file 23. Then, the safety management program 16 opens the dangerous-point information file 24, acquires the value of a field “Dangerous-points Information (text)” in each record, and displays each value in a list in the passing situation box 351.

The safety management program 16 further opens the latest record in the results data file 26, and acquires the value of the field “Location Information” thereof. Because this information is numeric, i.e., latitude and longitude, it is judged whether the vehicle has passed a dangerous point by comparing the location information in the results data file 26 to the value of a field “Dangerous-points Information (numeral)” in the dangerous-points information file 24. If the vehicle has passed, the safety management program 16 displays “Passed” in a corresponding line in the passing situation box 351.

As for excessive speeding, the safety management program 16 judges how many times 60 km/hr, which is the local-road speed limit, is exceeded in the whole operation route. That is, the safety management program 16 counts the number of records where the value of the field “Instantaneous Speed” is over 60 km/hr in the results data file 26. In this, if the excessive speeding is judged on two or more succeeding records, the safety management program 16 recognizes it as one time. The number of total times of the excessive speeding is displayed in the excess times box 352.

Still, this part is made customizable, enabling a vehicle operating company to set their own speed limit. For instance, it is possible to set 50 km/hr as the limit speed within a whole route, or to set a speed limit lower than a statutory speed limit. According to data from an ETC (Electric Toll Collection) on-vehicle device (described later) or to the location information, for instance it can be judged that a vehicle enters a specific highway. In this timing, the speed limit may be switched to 90 km/hr.

As shown in FIG. 19, a command button 353 captioned “Alarm Dangerous Point to Driver”, hereafter “danger notification button”, is provided at the lower left in the safety management window. By clicking the danger notification button 353, a variable concerning danger notification on the safety management program 16 is changed, thereby switching the mode of the on-vehicle device application to the notification mode. In the notification mode, when it is judged the vehicle is approaching a dangerous point on the basis of the location information transmitted from the general-purpose terminal 4, a sound file to announce “the vehicle is approaching a dangerous point. Please be cautious.” is transmitted to the general-purpose terminal 4.

A command button 354 captioned “Update” is provided in the safety management window. When this button 354 is clicked or tapped, the values of the fields in the record of the results data file 26 are read out again, and the contents of the passing situation box 351 and the excess time box 352 are refreshed according to the re-acquired values. Moreover, the configuration where the contents are updated automatically at every constant interval may be adopted.

In the described safety management program 16, the speed limit information in each part of a route may be recorded in a file beforehand and memorized in the storage device 2 of the management server 1. This configuration is useful in counting times of the excessive speeding in every shorter period referring the recorded information.

As shown in FIG. 19, a map box 355 to display the current location of a vehicle, and boxes to display the current location both as a numeral and as a string are provided for reference in the safety management window. Moreover, a box to display the triple element may be provided substitutionally or additionally.

Next, the whole operation management using the above system of this embodiment is described schematically.

A vehicle operating company installs the speed data acquisition unit 5 to each vehicle where the operation management needs to be carried out. The company also installs the terminal holder 741 in each vehicle. The on-vehicle device application is provided by the system provider, and is installed in each general-purpose terminal 4 to be used. The ope-management application is also provided by the system provider, and installed in each management terminal 3. Then, the vehicle operating company makes a use agreement for the services on the management server 1 with the system provider, and makes the management terminal 3 capable of executing each program on the management server 1.

A driver brings a general-purpose terminal 4 into a vehicle in a work (in a daily routine work), and mount it in the terminal holder 741. The driver connects the general-purpose terminal 4 to a cigar socket with a USB power cable. The driver turns on the power switch of the general-purpose terminal 4, starting the OS. Then, the driver starts the on-vehicle device application. After carrying out vehicle selection and route selection according to the work start module 42, the driver inputs the user ID, making a login to the management server 1. As a result, the work registration program 12 is executed. The work registration program 12 adds a new record in the work information file 25, and newly creates a results data file 26. On the other hand, the driver starts the vehicle as the login status is held, starting the work.

The driver loads goods into the vehicle at a designated place, transports them to another designated place, unloads them there, and then returns to a terminal. During the operation, the speed data acquisition unit 5 acquires the speed data from the sensor 8, and carries out interrupt transfer of the information at the input ports A-H with the speed data to the general-purpose terminal 4 via the USB cable at every device interval.

The on-vehicle device application refers to the USB input port at every acquisition interval, reads out contents of the temporary file (universal format file, e.g., CSV) having been transferred, and records them in the temporary file. Thus, the data transmission sub 432 is executed at every transmission interval, transmitting the contents of the temporary file to the management server 1. On the management server 1, the results data registration program 11 is called from the data transmission sub 432, and then executed. The results data registration program 11 adds a new record in the results data file 26, and records the transmitted contents therein. The travel speed is calculated from the vehicle speed pulse. The rotation number is calculated from the rotation-number pulse. Those are recorded in the new record of the results data file 26 as well.

While the operation is carried out, the driver may take a rest, refuel, or do other things. In taking a rest, the driver taps the rest button 415 in the on-vehicle device main window. As a result, the state variable is changed to “5”, which is reflected in the information to be transmitted to the management server 1 by the data transmission sub 432. Similar for refueling, carwashing and others, as a result of tapping each of the buttons 411-419, the state variable is changed, which is reflected to the information to be transmitted to the management server 1. Therefore, the value of the state variable in each acquisition interval is recorded in the field “Work Situation” of the results data file 26.

On the other hand, a person in charge of the management in the vehicle operating company makes a login to the management server 1 by using the management terminal 3. By clicking the work selection button 311 in the application top window, the person in charge of the management displays the work selection window, and selects a work therein. Thus, the person in charge of the management displays one of the management windows, and carries out the operation management. In confirming situation of the digi-tacho triple element in a specific past work, for instance, he/she displays the triple element browse window of FIG. 16 by clicking the triple element browse button 312. In carrying out the eco-evaluation on a selected work, he/she displays the eco-evaluation window shows in FIG. 18 by clicking the eco-evaluation button 313.

In carrying out the management on a work of the day, he/she selects a specific driver in the work selection window, and selects “That Day” for the date. And, by clicking the inspection-monitoring button 314, for instance, the inspection-monitoring window of FIG. 17 is displayed. In carrying out the safety management, the safety management window of FIG. 19 is displayed by clicking the safety management button 315. In these, abnormality may be alarmed to the driver by clicking the voice notification button 338. By clicking the danger notification button 353, it may be alarmed to the driver that the vehicle is approaching to a dangerous point. These are done appropriately.

Likewise, the driver carries out everyday work, and the person in charge of the management carries out the operation management by using the management terminal 3. When the vehicle returns to the terminal, the driver taps the work completion button 419 in the on-vehicle device main window on the general-purpose terminal 4. As a result, the access to the management server 1 is ended i.e., a logoff is done, and the work finishing module is executed. The work finishing module exports the data to a backup file in the storage device of the general-purpose terminal 4, and then makes the on-vehicle device application end. After this, the driver demounts the general-purpose terminal 4 from the terminal holder 741, and put it back to an original location. In the next work, the driver mounts the general-purpose terminal 4 in the terminal holder 741 again. Demount and mount of the general-purpose terminal 4 are not indispensable. When the same vehicle is supposedly used in the next work, the general-purpose terminal 4 may be left mounted.

In the described operation management, all contents recorded in the temporary file in one day work or in one time work are recorded similarly in the backup file memorized in the storage device of the general-purpose terminal 4. The backup file is referred and copied if necessary in the vehicle operation management. In case the results data is not transmitted to the management server 1 due to a communication trouble, for instance, the data during the trouble is copied from the backup file, and recorded in the results data file 26.

In the described vehicle operation management system of the embodiment, the on-vehicle device comprises the speed data acquisition unit 5 and the general-purpose terminal 4. The general-purpose terminal 4 performs the main function of transmitting the speed data to the management terminal 3. Because the general-purpose terminal 4 is a smartphone or tablet PC, it is rather cheap, and can be used commonly for other uses. Therefore, the cost for introducing the system of this embodiment is much lower than conventional systems.

Additionally, the speed data acquisition unit 5 has the simple configuration where only the signal from the sensor 8 on a drive mechanism and the signals from other on-vehicle devices are collected and transferred to the general-purpose terminal 4. Therefore, it is very cheap. In this point as well, the cost for introducing the system of this embodiment is cheap.

The input ports F-H in the speed data acquisition unit 5 are made vacant as described. When it is required to manage another item in the digi-tacho system accompanied by change of a low, change of an administrative guidance or any other change in the circumstance, a signal wire from a sensor in the vehicle is connected with one of the vacant input ports responding to it. Only by this, information on the other item is recorded in the results data file in the storage device 2. By implementing a browse program adequately on the management server 1, therefore, management of the other items is easily enabled. Thus, the system of this embodiment is convenient and low cost also in view of extendibility.

Collection of input data from another on-vehicle device may be carried out on the general-purpose terminal 4 without the speed data acquisition unit 5. In this case, though the other on-vehicle device is connected directly to the general-purpose interface input ports by an adequate adaptor cable, the number of the general-purpose interface input ports on the general-purpose terminal 4 is limited. Considering it is a portable type, the number of the general-purpose interface ports would be small. Though the tree type connection of USB cables can be adopted, the complexity might cause a trouble. By providing a sufficient number of input ports on the speed data acquisition unit 5, the system would be free from this kind of trouble, responding to increase of the data sources easily.

The general-purpose terminal 4 functions as a transit port in transmitting data from the speed data acquisition unit 5, not carrying out large volume data processing. In this embodiment, calculation of the instantaneous speed from the vehicle speed pulse and calculation of the rotation number from the rotation-number pulse are carried out not by the general-purpose terminal 4 but by the program on the management server 1, concretely, the results data registration program. Therefore, the data transfer speed may not be made slow, realizing the prompt registration of results data. Because the general-purpose terminal 4 transfers data through a mobile communication network such as cellular phone line and wireless LAN, the data transfer speed tends to be slower than wire transferring. Considering this, the load on the general-purpose terminal 4 in transferring data is made as small as possible in the embodiment. Therefore, calculation of the travel speed from the vehicle speed pulse, and calculation of the rotation number from the rotation-number pulse are carried out on the management server 1. From a similar point of view, it may be adopted the configuration where export of contents of the temporary file to the general-purpose terminal 4 for backup is not carried out.

Still, the invention of this application excludes neither calculating the travel speed on the general-purpose terminal 4, nor calculating the rotation number on the general-purpose terminal 4. If the instantaneous speed and the rotational number are acquired as absolute values from a means provided in the vehicle, e.g., ECU (Engine Control Unit or Electrical Control Unit), no processing is required on the management server 1.

In this embodiment, the general-purpose terminal 4 is held so as not to fall down from the terminal holder 741 in the vehicle during running. This terminal holder 741 has the general-purpose interface port to be in contact with the general-purpose interface input port of the general-purpose terminal 4 when mounted. Because the general-purpose interface port of the terminal holder 741 and the speed data acquisition unit 5 are connected by a general-purpose interface cable, transfer of the speed data to the general-purpose terminal 4 is enabled only by mounting the general-purpose terminal 4 on the terminal holder 741. Therefore, this embodiment is very convenient. As the terminal holder 741, a cable-built-in-type where a cable having a general-purpose interface port on the top is built in the frame may be adopted too.

In the system of the embodiment, a vehicle is selected on the work start module 42 of the on-vehicle device application, and the vehicle ID of the selected vehicle is recorded in the work information file 25 on the management server 1. When each piece of information is browsed on the management terminal 3, the vehicle information is displayed too. Therefore, it is also possible to confirm which vehicle was used in carrying out a work.

This point is much important with respect to that the system of this embodiment employs the general-purpose terminal 4 as a component of the digi-tacho on-vehicle device. In addition to the described merit, there is a further merit that it can be mounted to another vehicle easily. For instance, supposedly one general-purpose terminal 4 is deposited to one driver for the exclusive use. In this case it may be switched to another vehicle and mounted thereon when the driver carries out a work using the other vehicle. When the operation is carried out as such, data source for the general-purpose terminal 4, i.e., vehicle, would be different in each work, though the same driver use it. In this case, in carrying out the management according to property of each vehicle, e.g., refrigerator temperature, in addition to driving skill of drivers and others, it is necessary to identify each vehicle.

Because a digi-tacho on-vehicle device is fixed on a vehicle and used only for the vehicle, i.e., not demountable, in a conventional system, the ID of the digi-tacho on-vehicle device equals to the vehicle ID. That is, a transmitter of the speed data always has the fixed relation of the one-to-one correspondence with a vehicle. Therefore, the conventional system only manages the ID of each digi-tacho on-vehicle device, not managing the vehicle ID in addition.

In this embodiment, on the other hand, one general-purpose terminal 4 can be mounted on different vehicles as switched, and that is the advantage thereof. Therefore, it is desirable to identify which vehicle a general-purpose terminal is mounted on to be used, with respect to making the management elaborated according to property of vehicles. The work start module 42 and the work registration program 12 in the embodiment have this meaning of enabling the elaborate management according to the property of vehicles. By setting a standard refrigerator temperature for each vehicle and memorizing it in the vehicle information file 22, for instance, it is possible to check the refrigerator temperature in each vehicle during the operation.

Next, the vehicle operation management system of the second embodiment is described.

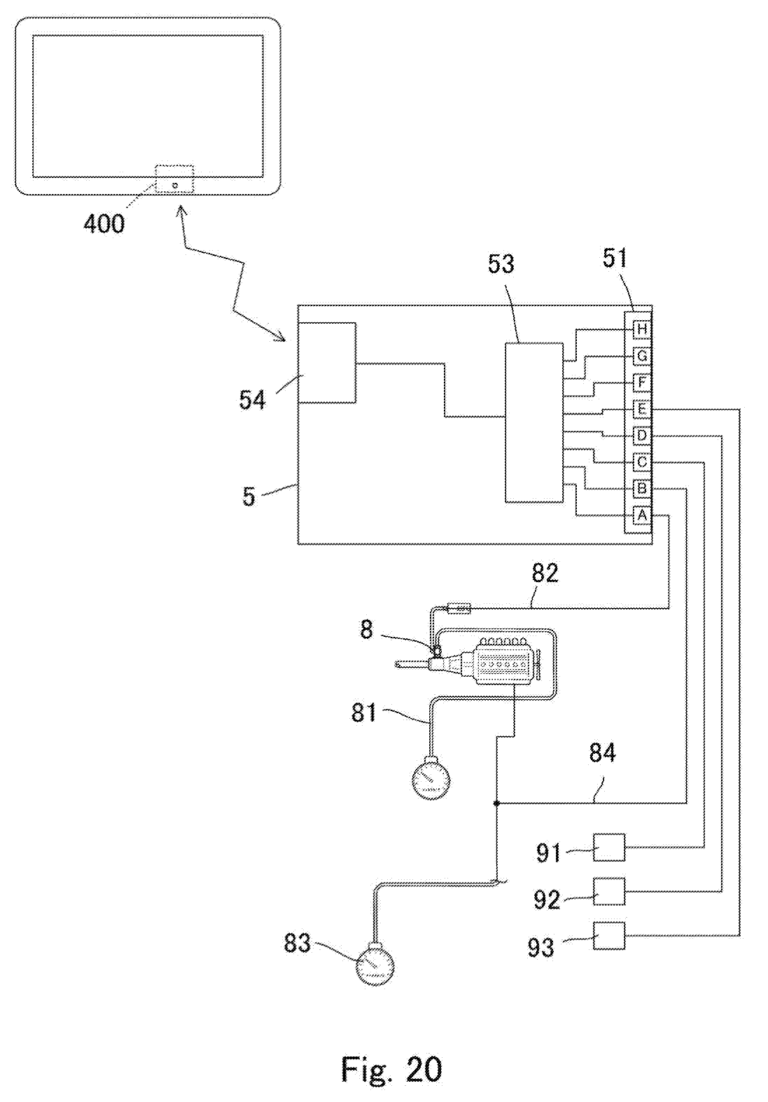

FIG. 20 schematically shows the main part of the vehicle operation management system of the second embodiment. The system of the second embodiment carries out a different type data transfer between the speed data acquisition unit 5 and the general-purpose terminal 4. In the second embodiment, the speed data acquisition unit 5 and the general-purpose terminal 4 carries out the data transfer by a type of short-distance wireless communication. As shown in FIG. 20, concretely, the general-purpose terminal 4 has a short-distance wireless receiver 400 based on a general-purpose interface standard, and the speed data acquisition unit 5 has a short-distance wireless transmitter 54 based on the same general-purpose interface standard as the receiver 400 on the general-purpose terminal 4.

As the short-distance wireless transmission standard, the infrared date communication or Bluetooth (registered trademark of Bluetooth SIG) is typically used. Almost all smartphones and portable computers have both types of wireless transmitters and receivers.

The speed data acquisition unit 5 only has to have a short-distance wireless transmitter of either one type or the other, though it may have the both. The speed data acquisition unit 5 has a short-distance wireless transmitter 54 to transmit data by, for instance, Bluetooth. The short-distance wireless transmitter 54 is an element replacing the output member in the first embodiment, and transfers the data from the output processor 53 by a protocol and radio wave based on the Bluetooth standard.

Bluetooth is more suitable for the system of the embodiment, compared to infrared date communication (IrDA). Though a transmitter and a receiver must face closely to each other in infrared date communication, those do not need to face to each other in Bluetooth. Moreover, it is possible to transmit and receive data even if those are distant further to some extent, compared to infrared date communication. As understood from FIG. 2, the speed data acquisition unit 5 and the general-purpose terminal 4 are often mounted on the dashboard. In this structure, it is difficult to mount them facing to each other. Therefore, Bluetooth is more preferable. Any transmitter and receiver based on another standard are preferably adopted as far as those enables wireless communication without facing. When the data transfer is carried out by the infrared date communication, it is preferable to adopt a wireless transmitter including a L-shaped rod antenna for the speed data acquisition unit 5, and make the top of the antenna directed to the wireless receiver of the general-purpose terminal 4.

The second embodiment is the same as the first embodiment, excepting that the data communication type is different. Therefore, the detailed description is omitted. Also because the general-purpose terminal 4 is adopted as the element of the on-board device, the cost for introducing the system is cheap. And, the system is preferable because the general-purpose terminal 4 may not fall down during the vehicle running. In the second embodiment, transfer of the speed data is carried out by the wireless communication. Therefore, it has the advantage of being free from wiring complication. That is, the interior of a vehicle is free from being messy by an exposed cable.

The terminal holder 7 in the first embodiment is the special-use holder for the general-purpose terminal 4, because the connector port 76 has to be provided to the position corresponding to the general-purpose interface port (USB port) of the general-purpose terminal 4. Though such a holder, i.e., on-vehicle holder for a smartphone or tablet PC, is on sold, it needs to be newly developed for the special use if available holders have neither connector ports nor external USB ports (nor locating at adequate positions). In the second embodiment, no special terminal holder 7 needs to be newly developed. The user does not need to buy a special terminal holder 7 either. These points are the advantages of the second embodiment.

Though omitted in the above description, it is assumed that one driver uses one general-purpose terminal 4 exclusively in the embodiments. Still, this is not indispensable for the invention. Two or more drivers may share one general-purpose terminal 4. In this case, the on-vehicle device application preferably includes a terminal ID as local setting information. The terminal ID is created automatically and recorded as the setup information when the on-vehicle device application is installed. The work start module 42 is programmed so as to transmit the terminal ID together in transmitting the driver ID to the management server 1. The terminal ID of each terminal used in each work is also recorded in the work information file 25. The system configured as such is preferable, because it can be judged from which general-purpose terminal contents of the temporary file should be imported when the backup file needs to be referred.

In the vehicle operation management system of the described embodiments, the triple element data, which is acquired from the speed data acquisition unit 5 and recorded in the results data file of storage device 2 via the general-purpose terminal 4 and the management server 1, must be free from falsification. This is to obey the guidance by MLIT. Technically, contents of the temporary file can never be falsified, because it is deleted on the general-purpose terminal 4 without being manipulated remotely. The backup file is memorized in the storage device on the general-purpose terminal 4 as the file with no change permission, or is not left on the general-purpose terminal 4 at all. No change permission is issued for the results data file 26 as a master file either, excepting addition of records during work execution.

Though not described, the signals such as one from a door sensor may be those according to the CAN (Controller Area Network) interface. The signal input to the speed data acquisition unit 5 may be the CAN interface signal as well. In this case, the on-vehicle device application on the general-purpose terminal 4 may convert the data adequately based on the CAN interface, and transmit it to the management server 1.

The signal input to the speed the data acquisition unit 5 may be a signal from an ETC on-vehicle device. Some ETC on-vehicle devices on sale have external output ports. Data may be acquired by connecting a signal wire from such an ETC on-vehicle device to the speed data acquisition unit 5. As an assumable example, whether a vehicle has entered an expressway is judged according to the data from an ETC on-vehicle device, and the speed limit value in the safety management is changed responding to it. The data from an ETC on-vehicle device can be used for the toll roads cost management (expense management) too.

In each embodiment described above, it is also possible to make contents of the results data file 26 browsable on the general-purpose terminal 4 in a vehicle. Concretely, a browse mode is newly implemented and made selectable on the on-vehicle device application. In the browse mode, the on-vehicle device application is programmed so as to display the triple element data recorded in the results data file 26 on the general-purpose terminal 4. Because a driver can confirm the digi-tacho triple element, the eco-evaluation and the like during his/her work on the general-purpose terminal 4, he/she would take care of himself/herself so as to drive more appropriately. Therefore, the system becomes more suitable for carrying out the safe and eco-conscious vehicle operation.

Respecting to leaving log data of a vehicle operation on the vehicle itself, the system may have the configuration where contents of the results data file 26 is returned to the speed data acquisition unit 5 via the general-purpose terminal 4 to be memorized, or have the configuration where the results data is left on the speed data acquisition unit 5. Concretely, a built-in storage device such as RAM is provided in the speed data acquisition unit 5, enabling memorization of the results data. In the latter case, function of memorizing the data on each output port in the built-in storage device is added to the output processor 53 in the speed data acquisition unit 5. In case that an traffic accident takes place, for instance, contents of the results data left on the built-in, i.e., fixed, device in the vehicle could be an important evidence. In this case, by analyzing the results data memorized in the fixed storage device, the speed and the acceleration at the moment when the accident takes place can be calculated, which could be used as the evidence concerning the accident. Therefore, such a system is recommended in view of the safety management.

Though the data in the results data file 26 includes the digi-tacho triple element in the described embodiments, it may not include the digi-tacho triple element. For instance, only the instantaneous speed at each time may be memorized in the results data file 26, enabling browse of only time and instantaneous speed. In this case, the travel time may be calculated additionally only when it needs to be confirmed.

### DESCRIPTION OF CHARACTER

1: Management Server
11: Results Data Registration Program
13: Triple-Element Browse Program
14: Inspection-monitoring Program
15: Eco-evaluation Program
16: Safety Management Program
2: Storage Device
26: Results data file
3: Management Terminal
4: General-Purpose Terminal
43: Data memorization module
400: Short-Distance Wireless Receiver
5: Speed Data Acquisition Unit
51: Input Member
52: Output Member
521: USB Port
53: Output Processor
54: Short-Distance Wireless Transmitter
6: Internet
7: Terminal holder
76: Connector Port
8: Sensor

1. A vehicle operation management system comprising a tachograph on-vehicle device mounted on a vehicle, a management server and a storage device,
wherein
the tachograph on-vehicle device comprises
a terminal that is a smartphone or tablet computer, and
a signal collecting unit to collect vehicle information to transmit to the terminal,
the terminal is capable of accessing the management server via a packet communication system,
a vehicle speed pulse is included in the vehicle information collected by the signal collection unit,
the terminal is the one to transmit the vehicle information to the management server via the packet communication system,
a program to memorize travel distance, travel time and travel speed by processing the vehicle speed pulse transmitted from the terminal is implemented on the management server, and
by being transmitted from the management server to an in-office terminal via the Internet, the travel distance, the travel time and the travel speed are capable of being browsed on the in-office terminal.

2. A vehicle operation management system comprising a tachograph on-vehicle device mounted on a vehicle, a management server and a storage device,
wherein
the tachograph on-vehicle device comprises
a speed data acquisition unit connected with a speed sensor provided on a drive mechanism of the vehicle, and
a general-purpose terminal connected with the speed data acquisition unit,
the general-purpose terminal is a smartphone or a mobile computer excluding smartphones, which is capable of accessing the management server via a network,
in the general-purpose terminal is installed an on-vehicle device application software including a data memorization module to transmit the speed data to the management server at every transmission interval and make the speed data memorized in the storage device, the speed data being acquired by the speed data acquisition unit at every acquisition interval,
the management server is the server to receive an access from the general-purpose terminal via the network,
vehicle operation management server software including a results data registration program is implemented on the management server,
a results data file is memorized in the storage device,
the results data registration program is the program to record the speed data transmitted from the general-purpose terminal by the data memorization module in the results data file for registration,
the vehicle operation management server software includes a triple element browse program,
the triple element browse program is the program to display the triple element on a management terminal on the basis of the speed data recorded in the results data file, the triple element being travel distance, travel time and travel speed in one day work or one time work,
a terminal holder is fixed on the vehicle, the terminal holder holding the general-purpose terminal demountably and pretending the general-purpose terminal from falling down during the vehicle running,
the speed data acquisition unit and the general-purpose terminal are capable of transferring the speed date either by a general-purpose interface cable connection or short-distance wireless communication.

3. A vehicle operation management system as claimed in the claim 2,
wherein
the speed data acquisition unit has a general-purpose interface output port,
the terminal holder has a general-purpose interface connector port to be in contact with a general-purpose interface input port of the general-purpose terminal mounted thereon,
the general-purpose interface connector port is connected to the general-purpose interface output port of the speed data acquisition unit by a general-purpose interface cable.

4. A vehicle operation management system as claimed in the claim 2, wherein
the general-purpose terminal has a short distance wireless receiver based on a general-purpose interface standard,
the speed data acquisition unit has a general-purpose interface transmitter based on the same general-purpose interface standard as the short distance wireless receiver of the general-purpose terminal.

5. A vehicle operation management system as claimed in the claim 4,
the general-purpose interface transmitter and the short-distance wireless receiver are capable of data transfer without facing to each other.

6. A vehicle operation management system as claimed in the claim 2,
wherein
the vehicle belongs to a vehicle operating company,
another or other vehicles belong to the same vehicle operating company,
the speed data acquisition unit and the general-purpose terminal are mounted on each vehicle,
in the storage device are memorized a vehicle information file where vehicle information including vehicle ID of each vehicle is recorded, and a work information file where work information is recorded,
a work registration program is included in the vehicle operation management server software,
the on-vehicle device application software includes a work start module to be executed in starting a work,
the work start module is the program module to make the vehicle ID input, transmit the vehicle ID to the management server so that the vehicle ID is recorded in the work information file by the work registration program,
the triple element browse program is the program to acquire information of the vehicle as data source from the vehicle information file and make the information displayed on the management terminal together with the triple-element.

7. A vehicle operation management system as claimed in the claim 2,
wherein
the speed data acquired by the speed data acquisition unit is vehicle speed pulse,
the results data registration program implemented on the management server is the program to calculate the travel speed by converting the vehicle speed pulse.

8. A vehicle operation management system as claimed in the claim 2,
wherein
the speed data acquisition unit has an input port to which a signal from anther device mounted on the vehicle than the speed sensor is input,
the speed data acquisition unit is the unit to output data based on the signal from the other device together with the speed data to the general-purpose terminal,
the data memorization module collects the data based on the signal from the other device and the speed data to transmit to the management server,
the results data registration program is the program to record the data based on the signal from the other device together with the speed data in the results data file.

9. A vehicle operation management system managing at least vehicle travel speed, comprising a tachograph on-vehicle device mounted on a vehicle, a management server and a storage device,
wherein
the tachograph on-vehicle device comprises
a speed data acquisition unit connected with a sensor provided on a drive mechanism of the vehicle, and
a general-purpose terminal connected with the speed data acquisition unit,
the general-purpose terminal is a smartphone or a mobile computer excluding smartphones, which is capable of accessing the management server via a network,
in the general-purpose terminal is installed on-vehicle device application software including a data memorization module to transmit the speed data acquired by the speed data acquisition unit to the management server,
the management server is the server to receive accesses from the general-purpose terminal and a management terminal via the network,
vehicle operation management server software including a results data register program is implemented on the management server,
a results data file is memorized in the storage device,
the results data registration program is the program to record the speed data transmitted from the general-purpose terminal by the data memorization module in the results data file for registration,
the vehicle operation management server software includes a browse program,
the browse program is the program to display the speed data recorded in the results data file on the management terminal,
a terminal holder is fixed in the vehicle, the terminal holder holding the general purpose terminal demountably and pretending the general-purpose terminal from falling down during the vehicle running,
the speed data acquisition unit and the general-purpose terminal are capable of transferring the speed data either by a general-purpose interface cable connection or short-distance wireless communication.

10. A vehicle operation management system as claimed in the claim 3,
wherein
the vehicle belongs to a vehicle operating company,
another or other vehicles belong to the same vehicle operating company,
the speed data acquisition unit and the general-purpose terminal are mounted on each vehicle,
in the storage device are memorized a vehicle information file where vehicle information including vehicle ID of each vehicle is recorded, and a work information file where work information is recorded,
a work registration program is included in the vehicle operation management server software,
the on-vehicle device application software includes a work start module to be executed in starting a work,
the work start module is the program module to make the vehicle ID input, transmit the vehicle ID to the management server so that the vehicle ID is recorded in the work information file by the work registration program,
the triple element browse program is the program to acquire information of the vehicle as data source from the vehicle information file and make the information displayed on the management terminal together with the triple-element.

11. A vehicle operation management system as claimed in the claim 4,
wherein
the vehicle belongs to a vehicle operating company,
another or other vehicles belong to the same vehicle operating company,
the speed data acquisition unit and the general-purpose terminal are mounted on each vehicle,
in the storage device are memorized a vehicle information file where vehicle information including vehicle ID of each vehicle is recorded, and a work information file where work information is recorded,
a work registration program is included in the vehicle operation management server software,
the on-vehicle device application software includes a work start module to be executed in starting a work,
the work start module is the program module to make the vehicle ID input, transmit the vehicle ID to the management server so that the vehicle ID is recorded in the work information file by the work registration program,
the triple element browse program is the program to acquire information of the vehicle as data source from the vehicle information file and make the information displayed on the management terminal together with the triple-element.

12. A vehicle operation management system as claimed in the claim 3,
wherein
the speed data acquired by the speed data acquisition unit is vehicle speed pulse,
the results data registration program implemented on the management server is the program to calculate the travel speed by converting the vehicle speed pulse.

13. A vehicle operation management system as claimed in the claim 4,
wherein
the speed data acquired by the speed data acquisition unit is vehicle speed pulse,
the results data registration program implemented on the management server is the program to calculate the travel speed by converting the vehicle speed pulse.

14. A vehicle operation management system as claimed in the claim 3,
wherein
the speed data acquisition unit has an input port to which a signal from anther device mounted on the vehicle than the speed sensor is input,
the speed data acquisition unit is the unit to output data based on the signal from the other device together with the speed data to the general-purpose terminal,
the data memorization module collects the data based on the signal from the other device and the speed data to transmit to the management server,
the results data registration program is the program to record the data based on the signal from the other device together with the speed data in the results data file.

15. A vehicle operation management system as claimed in the claim 4,
wherein
the speed data acquisition unit has an input port to which a signal from anther device mounted on the vehicle than the speed sensor is input,
the speed data acquisition unit is the unit to output data based on the signal from the other device together with the speed data to the general-purpose terminal,
the data memorization module collects the data based on the signal from the other device and the speed data to transmit to the management server,
the results data registration program is the program to record the data based on the signal from the other device together with the speed data in the results data file.

16. A vehicle operation management system as claimed in the claim 6,
wherein
the speed data acquired by the speed data acquisition unit is vehicle speed pulse,
the results data registration program implemented on the management server is the program to calculate the travel speed by converting the vehicle speed pulse.

17. A vehicle operation management system as claimed in the claim 6,
wherein
the speed data acquisition unit has an input port to which a signal from anther device mounted on the vehicle than the speed sensor is input,
the speed data acquisition unit is the unit to output data based on the signal from the other device together with the speed data to the general-purpose terminal,
the data memorization module collects the data based on the signal from the other device and the speed data to transmit to the management server,
the results data registration program is the program to record the data based on the signal from the other device together with the speed data in the results data file.

18. A vehicle operation management system as claimed in the claim 7,
wherein
the speed data acquisition unit has an input port to which a signal from anther device mounted on the vehicle than the speed sensor is input,
the speed data acquisition unit is the unit to output data based on the signal from the other device together with the speed data to the general-purpose terminal,
the data memorization module collects the data based on the signal from the other device and the speed data to transmit to the management server,
the results data registration program is the program to record the data based on the signal from the other device together with the speed data in the results data file.
